(19) United States
(12) Patent Application Publication
(10) Pub. No.: US 2006/0234151 A1
(43) Pub. Date: Oct. 19, 2006

(54) Functional organic thin film, organic thin-film transistor, and methods for producing these

(76) Inventors: Masatoshi Nakagawa, Nara-shi (JP); Hiroyuki Hanato, Nara-shi (JP); Toshihiro Tamura, Shiki-gun (JP)

Correspondence Address: NIXON & VANDERHYE, PC, 901 NORTH GLEBE ROAD, 11TH FLOOR, ARLINGTON, VA, 22203, US

(21) Appl. No.: 10/559,535

(22) PCT Filed: Jun. 10, 2004
(86) PCT No.: PCT/JP04/08121

§ 371 Date: Dec. 2, 2005

(30) Foreign Application Priority Data
Jun. 11, 2003 (JP) 2003-166609
Jun. 25, 2003 (JP) 2003-181521

(51) Int. Cl. G03C 3/00

(52) U.S. Cl. 430/234

(57) ABSTRACT

A functional organic thin film comprising a network structure moiety 12 including silicon atoms and oxygen atoms and formed on a base 11; and a π-election conjugated system molecule 15 bonded to the network structure moiety 12 via an insulating molecule 14.

### TECHNICAL FIELD

The present invention relates to a functional organic thin film, an organic thin film transistor, and a method of forming them, and more particularly, concerns the functional organic thin film that is formed by binding an organic compound onto a molecular thin film having a periodic structure, a monomolecular accumulated film having a plurality of functions, an organic thin film transistor utilizing an accumulated film of insulating/conductive films, and a manufacturing method of them.

### BACKGROUND ART

Problems with the conventional technique of organic TFT and physical adsorption film

Recently, in contrast to semiconductors using inorganic materials, various attempt have been vigorously made in which: organic compounds, which are easily processed, and expected to be applied to large-size devices, to cut costs through mass production and to provide various functions, are formed into a thin film, and applied to a semiconductor device and the like, such as an organic photoelectric conversion element, an organic light-emitting film, an insulating film, a resist film and a non-linear optical element.

Among these, it is known that TFT having a great mobility can be manufactured by utilizing an organic compound containing a π-electron conjugated system molecule. With respect to this organic compound, as a representative, a pentacene has been reported (e.g. IEEE Electron Device Lett., 18, 606-608 (1997)). Therein, it has been reported that, when a pentacene is used to form an organic semiconductor layer and then TFT, it is possible to construct TFT having a greater mobility than that of amorphous silicon, because its field-effect mobility becomes 1.5 cm²/Vs.

However, when the organic compound semiconductor layer for obtaining a higher field-effect mobility than that of the aforementioned amorphous silicon is prepared, it needs a vacuum process such as a resistance heating vapor deposition method and a molecule beam vapor deposition method leading that its manufacturing step becomes troublesome and, at the same time, a film having crystallinity is obtained only under a particular condition. In addition, the organic compound film is adsorbed onto a substrate by physical adsorption which is low at strength, and is easily peeled. Further, in order to control molecular orientation of the organic compound in the film to a certain degree, a substrate on which the film is formed is usually in advance subjected to orientation controlling by rubbing treatment; however, in making the film by physical adsorption, there is no report that compatibility and orientation property of a molecule at an interface between a physical adsorbed organic compound and the substrate can be controlled.

Explanation of Self-Organizing Film and Necessity of Organic Silicon Compound

On the other hand, regarding regularity and crystallinity of the film that give great influences on a field-effect mobility which is a representative index of property of this TFT, since it is simple to manufacture the film, a self-organizing film using an organic compound has been recently paid an attention, and utilization of the self-organizing film has been studied.

The self-organizing film is binding of a part of the organic compound to a functional group on the substrate surface, and is a film having an extremely little defect, and having high ordering property, that is, crystallinity. Since this self-organizing film is extremely simple to manufacture it, it is easy to make a film on the substrate. A thiol film formed on a gold substrate, and a silicon-based compound film formed on a substrate on which hydroxyl group can be protruded on a surface by hydrophilization treatment (e.g. silicon substrate) are known as usual self-organizing films. Among these, from a viewpoint of high durability, the silicon-based compound film is paid an attention. The silicon-based compound film has been previously used as a water-repellent coating, and the film has been made using a silane coupling agent having an alkyl group or a fluorinated alkyl group as an organic functional group having a high water-repellent effect.

However, although electric conductivity of the self-organizing film is determined by an organic functional group in the silicon-based compound contained in the film, there are no commercially available silane coupling agents which have an organic functional group containing π-electron conjugated system molecule and, for this reason, it is difficult to impart electric conductivity to the self-organizing film. Therefore, it is expected that the silicon-based compound containing the π-electron conjugated system molecule as the organic functional group which is suitable in a device such as TFT is available.

Studies of Organic Silicon Compound and Problems Therewith

As such the silicon-based compound, a compound having one thiophene ring as a functional group at a terminal of a molecule in which the thiophene ring is bound to a silicon atom via a linear hydrocarbon group has been proposed (e.g. Japanese Patent No. 2889768: Patent Document 1). Further, as a polyacetylene film, a film in which a part of acetylene group is polymerized on a substrate by forming a —Si—O— network by a chemical adsorption method has been proposed (e.g. Japanese Examined Patent Publication No. HEI 6(1994)-27140: Patent Document 2). In addition, there is a proposal that, as an organic material, is used a silicon compound in which linear hydrocarbon groups are bonded to the 2- and 5-positions of thiophene ring respectively and a terminal of the linear hydrocarbon and a silanol group are bound. This silicon compound is self-organized on a substrate, and further polymerized by field-polymerization or the like to form an electrically conductive thin film, which is used as a semiconductor layer of an organic device (e.g. Japanese Patent No. 2507153: Patent Document 3). Further, a field-effect transistor utilizing a semiconductor thin film containing, as a main component, a silicon compound having a silanol group on thiophene ring contained in polythiophene has been proposed (e.g. Japanese Patent No. 2725587: Patent Document 4). Moreover, with respect to The method of utilizing the self-organizing property using an organic silicon compound, a method of forming an antistatic film through chemical adsorption has been proposed (e.g. Japanese Patent Application Laid-Open No. 5-202210).

However, although the afore-proposed compounds can manufacture a self-organized film which can be chemically adsorbed onto a substrate, a film having high ordering property, crystallinity and electric conductive property which can be used in an electronic device such as TFT could not be necessarily manufactured. Further, when the above-proposed compounds are used in a semiconductor layer of organic TFT, there is a problem that an off current becomes great. This is thought that all of proposed compounds have a bond in a molecular direction and a direction vertical to a molecule.

Another problem with the above-mentioned proposal is that, in general, the silanol group has high reactivity such that it reacts with moisture in the atmosphere to make it difficult to synthesize its compound except for one portion thereof. Therefore, from the viewpoints of economical efficiency and mass production, the technique for allowing an organic silane compound containing π-electron conjugated system molecules to preliminarily react with the substrate is not necessarily considered to form an optimal preparation method. For this reason, since the synthesis of a material containing π-electron conjugated system molecules is particularly difficult, there have been demands for separating the self-organizing film forming stage and the binding process of the π-electron conjugated system molecules from each other.

Conventional Examples of Two-Stage Preparation Method and Problems Thereof

With respect to the technique in which two stages, that is, the self-organizing film forming stage and a molecules of a second layer binding process, are prepared as the preparation method, for example, a chemical adsorption single molecule accumulation film and its preparation method have been proposed (for example, see Patent Document 6). In accordance with this preparation method, for example, after a chlorosilane compound such as SiCl₄ has been reacted with the surface of a substrate which bears an active hydrogen group such as a hydroxide group and an imino group thereon or has such a group applied thereto, a chlorosilane adsorbing agent having a fluoroalkyl group is allowed to react therewith to prepare a single molecule accumulated film.

However, the above-mentioned method is a preparation method that attempts to increase the number of reaction sites between the substrate and a silane compound, this method characterized in that no periodically arranged functional groups sticking out from the network formed as the first layer. Consequently, upon forming the accumulated film by using this method, a silane compound serving as the second layer is required, failing to solve the above-mentioned problems. In other words, in order to provide a preparation method for forming an organic thin film that is highly self-organized and applied to many substrate materials, it is necessary to provide a structure in which reaction sites with a second-layer material are allowed to periodically stick out of a network preliminarily formed on a substrate.

Patent Document 1: Japanese Patent No. 2889768

Patent Document 2: Japanese Examined Patent Publication No. HEI 6(1994)-27140

Patent Document 3: Japanese Patent No. 2507153

Patent Document 4: Japanese Patent No. 2725587

Patent Document 5: Japanese Patent Application Laid-Open No. 5-202210

Patent Document 6: Japanese Patent Application Laid-Open No. 5-86353

### DISCLOSURE OF THE INVENTION

The present invention was clone in view of the aforementioned problems, and an object of the present invention is to provide an organic thin film which is applicable to many materials, and achieves both of a chemical structure of an organic material as a factor determining properties of a thin film and a primary structure of the film such as an orienting property of molecules, as well as a high-order structure of a film, for example, crystallinity and orienting property, and to achieve a manufacturing method which is used for providing, through simple processes, a functional organic thin film that allows a main skeleton portion of molecules forming a film to optionally have functions such as electric, optical and electro-optical properties, and the functional organic thin film that is obtained through such a method.

Moreover, another object of the present invention is to provide an organic thin film transistor with high performances and high reliability in which accumulated films stacked through chemical bonds are formed by utilizing a self-organized property to improve interface compatibility so that leak current to the outside of the film is suppressed to a low level and so that functions such as electric, optical and electro-optical properties of main skeleton portions of accumulated molecules are allowed to optionally exert as functions of the organic thin film transistor on demand, and a manufacturing method of such an organic thin film transistor.

### BEST MODE FOR CARRYING OUT THE INVENTION

Explanation of Functional Organic Thin Film

Thus, the present invention makes it possible to provide a functional organic thin film comprising a network structure moiety including silicon atoms and oxygen atoms and formed on a base; and a π-electron conjugated system molecule bonded to the network structure moiety via an insulating molecule.

In the functional organic thin film of the present invention, the network structure moiety may has a Si—O—Si bond. Moreover, the insulating molecule may be a linear alkyl molecule having 12 to 30 carbon atoms. Here, the π-electron conjugated system molecule may include 2 to 30 linearly bonded units, each of the units constituting the π-electron conjugated system.

In the functional organic thin film of the present invention, each of the units constituting the π-electron conjugated system of the π-electron conjugated system molecule is one or more compounds selected from the group consisting of an aromatic hydrocarbon, a condensed polycyclic hydrocarbon, a monocyclic heterocyclic, a condensed heterocyclic, an alkene, an alkadiene and an alkatriene, may be used. Specific examples, each of the units constituting the π-electron conjugated system of the π-electron conjugated system molecule has an acene skeleton with 2 to 12 benzene rings or a π-electron conjugated system organic residue including at least one or more units of a monocyclic heterocyclic compound having Si, Ge, Sn, P, Se, Te, Ti or Zr as a hetero atom and one to nine units, selected from a group derived from a monocyclic aromatic hydrocarbon and a monocyclic heterocyclic compound, bonded to each other, and in this case, each of the units constituting the π-electron conjugated system of the π-electron conjugated system molecule is benzene, thiophene or ethylene.

With respect to the π-electron conjugated system molecules, detailed explanations thereof will be given in the preparation method thereof later.

The functional organic thin film is preferably set in 1 to 70 nm in total film thickness. When the film thickness of the functional organic thin film is 1 nm or less, the conductivity of the organic thin film becomes extremely low, failing to provide sufficient electrical properties. In contrast, when the film thickness exceeds 70 nm, it becomes difficult to sufficiently control the orienting property of the organic thin film. Therefore, in the case when the π-electron conjugated system layers are laminated, it becomes possible to obtain a film having superior electric properties in comparison with a monomolecular film. Moreover, this functional organic thin film may has molecular crystallinity.

In the present invention, the base can be properly selected depending on applications of the organic thin film, and examples thereof include a single layer or a laminated layer made from: element semiconductors such as silicon and germanium; compound semiconductors such as GaAs, InGaAs and ZnSe; so-called SOI substrates, multilayered SOI substrates and SOS substrates or the like; glass and quartz glass; insulators like polymer films such as polyimide, PET, PEN, PES and Teflon (registered trademark); stainless steel (SUS); metals such as gold, platinum, silver, cupper and aluminum; high-melting-point metals such as titanium, tantrum and tungsten; silicide, polycide and the like with high melting point metals; insulators such as silicon oxide films (thermal oxidized film, low temperature oxidized film: LTO film, high temperature oxidized film: HTO film), silicon nitride film, SOG film, PSG film, BSG film and BPSG film; PZT, PLZT, ferroelectric or antiferroelectric; low dielectric such as SiOF-based film, SiOC-based film or CF-based film, HSQ (hydrogen silsesquioxane)-based film formed by applying (inorganic-based), MSQ (methyl silsesquioxane)-based film, PAE (polyarylene ether)-based film, BCB-based film, porous-based film or CF-based film, or porous film. Among these, a base, which allows active hydrogen, such as a hydroxide group and a carboxyl group, to stick out of the surface, or a base, which allows active hydrogen to stick out through a hydrophilization treatment, may be used. With respect to the hydrophilization treatment, for example, a method in which the base is immersed in a mixed solution between hydrogen peroxide and sulfuric acid may be used.

The following description will discuss a preparation method of a functional organic thin film of the present invention.

Explanation of Preparation Method (i)

In accordance with another aspect of the present invention, the present invention provides a preparation method (i) of a functional organic thin film, comprising: a first step of forming a molecular thin film on a surface of a base, the molecular thin film having first functional groups periodically sticking out therefrom; and a second step of allowing second functional groups of organic compounds to react with the first functional groups of the molecular thin film or third functional groups formed by converting the first functional groups so that an organic thin film in which the organic compounds are bonded and periodically arranged is formed on the molecular thin film. Here, the expression “with functional groups periodically sticking out” indicates a state in which functional groups serving as side chains are periodically oriented on the surface of each of molecules (in this case, organic silane compound) forming the molecular thin film.

In other words, in the preparation method (i) of the functional organic thin film of the present invention, first, in the first process of forming periodic reactive sites, the molecular thin film with a self-organizing function, which has a structure with the first functional groups periodically sticking out, is formed on a substrate, and in the second process, each of the first functional groups of the molecular thin film or each of third functional groups formed by converting each of the first functional groups to another substituent is allowed to react with the second functional group of the organic compound so that a functional organic thin film in which the main skeleton of the organic compound is periodically arranged on the molecular thin film is formed.

In accordance with the preparation method (i) of the functional organic thin film of the present invention, any organic material (organic compound) can be freely selected and used as long as it contains a functional group that reacts with each of functional groups that stick out of the molecular thin film; therefore, by selecting an organic material suitable for a target function, a functional organic thin film to be used for various applications is easily obtained. Moreover, by using, for example, a silane compound as a material for forming the molecular thin film, the functional organic thin film, formed on the base, has a structure in which, in accordance with a network of the molecular thin film with silicon atoms and oxygen atoms being formed in a network structure, the organic compound, formed thereon, is periodically arranged so that it becomes possible to construct a self-organizing monomolecular film that has been highly crystallized. Here, the “self-organizing” property is a property possessed by some of organic compounds, in which mutual material molecules are automatically oriented through Van der Waals interaction without the necessity of a specific orienting treatment. Moreover, for example, by using an organic material containing π-electron conjugated system molecules, a functional organic thin film, which has a stacked structure through an intermolecular interaction, is formed so as to have high conductivity in a direction perpendicular to the substrate surface and also to effectively obtain overlapped orbits among molecules in a plane direction; consequently, it is possible to obtain a superior semiconductor property that exerts electrical anisotropy. In other words, since the intermolecular distance between the π-electron conjugated system molecules located on an upper portion of the network becomes smaller, the conductivity in a direction perpendicular to the molecular plane exerted by hopping conduction becomes higher, and a functionality that exerts high conductivity in a molecular axis direction is obtained; therefore, the resulting conductive material can be widely applied not only to organic thin film transistor materials, but also to devices such as solar cells, fuel cells and sensors. Moreover, different from the conventional material, it is not necessary to synthesize an organic material having high reactivity so as to provide the material; consequently, it becomes possible to use organic materials that are general-use materials widely applied, and also to manufacture organic thin films that are generally applicable, and since no de-vacuuming process is required, the manufacturing process can be simplified.

In the preparation method (ii) of the present invention, with respect to the material forming the molecular thin film to be used in the first process, it is important to use a material that allows functional groups to periodically stick out of the surface after the molecular thin film has been formed, and specific examples include silane compounds. Although not particularly limited, as long as it is a silane compound that has a portion used for forming a network structure film moiety (network) made of silicon atoms and oxygen atoms serving as constituent atoms and a portion that reacts with an organic compound to be laminated as a second layer after the formation of the molecular thin film, among silane compounds, when taken into consideration a structure in which functional groups are allowed to periodically stick out from a network in which silicon atoms and oxygen atoms are formed in a network structure on the base in the first process, those silane compounds in which each silicon atom has three functional groups used for forming the network and one functional group (first functional group) to be laminated with the second layer are preferably used, and for example, trihalogen silane having a first functional group, more specifically, vinyltrichlorosilane, may be used. Here, with respect to the first functional group, those having a vinyl group have been exemplified; however, other substituents, such as an amino group, a carboxyl group, an acyl group, a formyl group, a carbonyl group, a nitro group, a nitroso group, an azide group, an acid azide group, an acid chloride group and the like may be used.

Here, with respect to the three functional groups used for forming the network structure film moiety made from silicon atoms and oxygen atoms, any functional group may be used as long as it provides a hydroxide group through hydrolysis, and in addition to halogen atoms (Cl, F, Br or the like) of trihalogeno silane, an alkoxy group or the like having a carbon number of 1 to 4 may be used as well.

In this manner, by using a silane compound as the material for forming a molecular thin film, the functional organic thin film, formed on the base, allows its upper portion organic compound to be periodically arranged in accordance with a network of the molecular thin film in which silicon atoms and oxygen atoms are formed in a network structure so that it becomes possible to construct a self-organizing monomolecular film that is highly crystallized.

As described above, by using a silane compound as the material for forming a molecular thin film, the organic thin film, formed on the surface of the base, allows its upper portion organic compound to be periodically arranged in accordance with a network in which silicon atoms and oxygen atoms of an lower portion molecular thin film are formed in a network structure so that it becomes possible to construct a self-organizing monomolecular film that is highly crystallized.

Moreover, with respect to the first functional group of the silane compound to be laminated with the second layer, any functional group may be used as long as it reacts with reaction sites (the second functional group) of the organic compound to be reacted as the second layer, and examples thereof include: various functional groups, such as an amino group, a carboxyl group, an acyl group, a formyl group, a carbonyl group, a nitro group, a nitroso group, an azide group, an acid azide group and an acid chloride.

Each of these first functional groups may be desirably protected by a protective group. In other words, each of these first functional groups is not intended to be limited by a substituent (second functional group) of the organic compound that is allowed to react in the second process, and, for example, such a group, which is converted into a third functional group that reacts with the organic compound to be reacted in the second process through processes of several stages (including, for example, a de-protecting process or the like) between the first process and the second process, may be used in other words, the preparation method (i) of the present invention may further comprising, between the first step and the second step, a middle step of converting the first functional groups of the molecular thin film to the third functional groups which can react with the second functional groups of the organic compounds. With respect to this substituent converting process, a reaction, such as a catalyst reaction and a photo-conversion reaction (for example, reduction from a nitro group to an amino group in the presence of a nickel catalyst) or a de-protecting process through hydrolysis may be used.

In the preparation process (i) of the present invention, with respect to the organic compound (organic compound used for forming a second layer) to be reacted in the second process, any compound may be used as long as it reacts with a functional group (the first or third functional group) sticking out of the molecular thin film formed in the first process, and from the viewpoint of preparing an organic thin film with high conductivity, the compounds having the second functional groups and main skeletons which are constituted of π-electron conjugated system molecules are preferably used, and from the viewpoints of yield and economical efficiency, the compounds in which each of the units constituting the π-electron conjugated system of the π-electron conjugated system molecule, has 30 or less units and the units being linearly bonded to each other, is more preferably used.

The functional organic thin film having such π-electron conjugated system molecules makes it possible to provide a stacked structure formed by utilizing an intermolecular interaction so as to have high conductivity in a direction perpendicular to the substrate surface and also to efficiently obtain overlapped orbits among molecules in a plane direction; consequently, it is possible to obtain a superior semiconductor property that exerts electrical anisotropy. In other words, since the intermolecular distance between the π-electron conjugated system molecules becomes smaller, the conductivity in a direction perpendicular to the molecular plane exerted by hopping conduction becomes higher, and a functionality that exerts high conductivity in a molecular axis direction is obtained; therefore, the resulting conductive material can be widely applied not only to organic thin film transistor materials, but also to devices such as solar cells, fuel cells and sensors.

Explanation of Preparation Method (ii)

In accordance with the present invention, the present invention provides a preparation method (ii) of a functional organic thin film, comprising: a first step of bonding insulating molecules to a base via a network structure moiety formed of silicon atoms and oxygen atoms, the insulating molecules having first functional groups at the terminals, and a second step of allowing second functional groups located at the terminals of π-electron conjugated system molecules to react with the first functional groups of the insulating molecules or third functional groups formed by converting the first functional groups so that the π-electron conjugated system molecules is bonded to the insulating molecules.

In accordance with the preparation method (ii) of the functional organic thin film of the present invention, monomolecular films having different functions are laminated by utilizing a self-organizing property so that it is possible to obtain a composite film in which respective portions of the film are highly solidified. More specifically, the composite film has a structure in which an insulating monomolecular film, constituted by a layered network structural moiety composed of silicon atoms and oxygen atoms bonded to the surface of a base and a layered insulating portion made from insulating molecules periodically arranged on the surface (on the side opposite to the base) of the network structure moiety, and a conductive film, made from π-electron conjugated system molecules bonded to the respective insulating molecules of the insulating monomolecular film, are laminated. The composite film having superior electric properties, which achieves both of a chemical structure of an organic material which are factors determining properties of a thin film and a primary structure of the film such as an orienting property of molecules, as well as a high-order structure of a film, for example, compatibility of a molecule at the interface. Moreover, in the vicinity of the border between the network structure moiety and the insulating portion of the insulating monomolecular film, silicon atoms and oxygen atoms are bonded to each other in a network structure through Si—O—Si bonds so that an intermolecular bond is further strengthened.

Moreover, since the composite film is formed by accumulating layers, any kind of material may be used as long as it is a functional group that reacts with each of the functional groups sticking out of the first layer; therefore, different from the conventional layer, it is not necessary to synthesize a material having high reactivity; consequently, it becomes possible to manufacture organic thin films that are more generally applicable.

Moreover, since no de-vacuuming process is required, the manufacturing process can be simplified, and since the accumulated films are chemically bonded to each other, the film is hardly subjected to degradation such as film separation so that a functional organic thin film having superior electrical properties can be formed.

Furthermore, it becomes possible to manufacture a composite film which is applicable to many compounds, and achieves both of a chemical structure of an organic material which are factors determining the properties of the thin film and a primary structure of the film such as an orienting property of molecules, as well as a high-order structure of a film, for example, compatibility of film interface.

In the preparation method (ii) of the present invention, with respect to the material for forming an insulating monomolecular film to be used in the first process, any compound may be used as long as it is a material having, for example, a conductivity of 10⁻¹⁰ S/cm or less in a direction in parallel with the base; however, from the viewpoint of forming a self-organizing monomolecular film, an organic silane compound containing an organic residue, which exerts an insulating function, is preferably used. With respect to the organic residue having an insulating function, for example, functional groups having no expansion of π-electron conjugated system, such as an allyl group and an oxymethylene group, are listed, and from the viewpoint of forming a highly oriented monomolecular film, an organic silane compound having a linear alkyl group having a carbon number of 12 to 30, with a functional group attached to its terminal, is more preferably used. In the case when the carbon number is less than 12, since the intermolecular interaction is low after the film formation, it becomes difficult to form an organic thin film that is highly oriented through a method utilizing the self-organizing property. In the case of the carbon number exceeding 30, since the chain length is too long, molecular chains are mutually entangled to intervene with the orientation, resulting in a failure in forming a highly-oriented organic thin film.

With respect to the functional group (first functional group) contained in a terminal of the insulating molecular of the insulating monomolecular film or the functional group (second functional group) contained in the π-electron conjugated system molecules constituting conductive films that are accumulated on the insulating monomolecular film, for example, various functional groups, such as an amino group, a carboxyl group, an acyl group, a formyl group, a carbonyl group, a nitro group, a nitroso group, an azide group, an acid azide group and an acid chloride group, may be used.

More specifically, with respect to the organic silane compound forming the insulating monomolecular film, an organic compound containing trihalogeno silane in its molecule, such as aminooctadecyl trichlorosilane, hydroxyloctadecyl trichlorosilane, hydroxyldodecyl trichlorosilane and aminododecyl trichlorosilane, is preferably used.

By using such an organic silane compound, the insulating monomolecular film, formed on the base surface, allows its upper layer insulating molecules to be periodically arranged in accordance with a network of its lower layer network structure moiety having Si—O—Si bonds so that it becomes possible to form a self-organized monomolecular film that has been highly crystallized.

In the preparation method (ii) of the present invention, the first functional group contained at the terminal of the insulating molecule constituting a insulating mono-molecule film may be desirably protected by a protective group. In other words, the first functional group is not intended to be limited by a functional group that is capable of reacting with the second functional group possessed by each π-electron conjugated system molecule (conductive molecule) to be accumulated on the insulating monomolecular film, and such a group, which converts the first functional group into a third functional group that reacts with the second functional group of the π-electron conjugated system molecule to be accumulated in the second process through processes of several stages (including, for example, a de-protection process or the like) prior to the accumulating process, may be used. In other words, the preparation method of the functional organic thin film of the present invention may include a process between the first process and the second process, in which the first functional group of the insulating monomolecular film is converted into a third functional group capable of reacting with the second functional group of the π-electron conjugated system molecule. With respect to this substituent converting process, a reaction, such as a catalyst reaction and a photo-conversion reaction (for example, reduction from a nitro group to an amino group in the presence of a nickel catalyst) or a de-protection process through hydrolysis may be used.

In the preparation process (ii) of the present invention, with respect to the material for the conductive film formed on the insulating monomolecular film through chemical bonds, any compound may be used as long as it has the second functional group that reacts with the first functional group or the third functional group converted from the first functional group of the insulating molecule, and from the viewpoint of preparing an organic thin film with high conductivity, an organic compound which has a plurality of π-electron conjugated system molecule units as its main skeleton is preferably used, and from the viewpoints of yield and economical efficiency, a compound in which 30 or less of the units are linearly bonded to one another is more preferably used.

Explanation of Organic Compound Used for Forming the Second Layer

In the preparation methods (i) and (ii) of the present invention, with respect to the organic compound used for forming the second layer, one or more compounds selected from the group consisting of an aromatic hydrocarbon, a condensed polycyclic hydrocarbon, a monocyclic heterocyclic, a condensed heterocyclic, an alkene, an alkadiene and an alkatriene, may be used.

More specifically, the organic compound used for forming the second layer may be prepared as each of the units constituting the π-electron conjugated system contained in the π-electron conjugated system molecule has an acene skeleton with 2 to 12 benzene rings, or each of the units constituting the π-electron conjugated system contained in the π-electron conjugated system molecule is a π-electron conjugated system organic residue including at least one or more units of a monocyclic heterocyclic compound having Si, Ge, Sn, P, Se, Te, Ti or Zr as a hetero atom and one to nine units, selected from a group derived from a monocyclic aromatic hydrocarbon and a monocyclic heterocyclic compound, bonded to each other.

With respect to the aromatic hydrocarbons, examples thereof include benzene, toluene, xylene, mesitylene, cumene, cumene, styrene and divinylbenzene. Among these, benzene is preferably used.

With respect to the condensed polycyclic hydrocarbons, examples thereof include: hydrocarbons containing an acene skeleton (the following structural formula 1), hydrocarbons containing an acenaphthylene skeleton (the following structural formula 2), hydrocarbons containing a perylene skeleton (the following structural formula 3), indene, azulene, fluorene, acenaphthylene, biphenylene, pyrene, pentalene and phenalene.

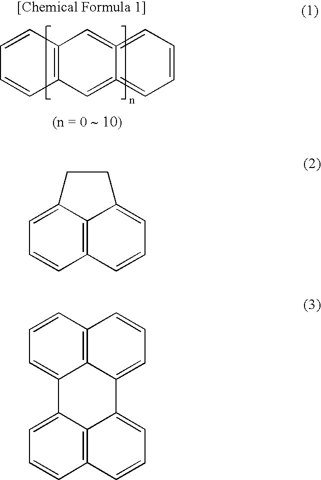

In the present invention, the acene skeleton includes not only a hydrocarbon having two or more benzene rings condensed in a straight manner, but also a hydrocarbon having three or more benzene rings condensed in a non-straight manner. In the present invention, the straight hydrocarbon containing the acene skeleton has a number of benzene rings of 2 to 12, and when the number of synthesizing processes and a yield of products are taken into consideration, hydrocarbons having 2 to 9 benzene rings, such as naphthalene, anthracene, naphthacene, pentacene, hexacene, heptacene, octacene and nonacene, are more preferably used. Moreover, with respect to non-straight hydrocarbons containing the acene skeleton, examples thereof include phenanthrene, crycene, picene, pentaphene, hexaphene, heptaphene, benzoanthracene, dibenzophenanthrene and anthranaphthacene, are preferably used.

The following description will discuss specific synthesizing methods of the acene skeleton indicated by formula (1). Here, these synthesizing methods are exemplary only, and other known synthesizing methods may be adopted.

With respect to the synthesizing method of the acene skeleton, for example, the following methods are listed: (1) a method in which processes in which, after substituting hydrogen atoms bonded to two carbon atoms at predetermined positions of a raw material compound with ethynyl groups, the mutual ethynyl groups are subjected to a ring-closing reaction are repeated, and (2) a method in which processes in which, after substituting hydrogen atoms bonded to carbon atoms at predetermined positions of a raw material compound with triflate groups, the resulting matter is reacted with furan or a derivative thereof and then oxidized are repeated. Examples of the synthesizing method of the acene skeleton using these processes are explained below.

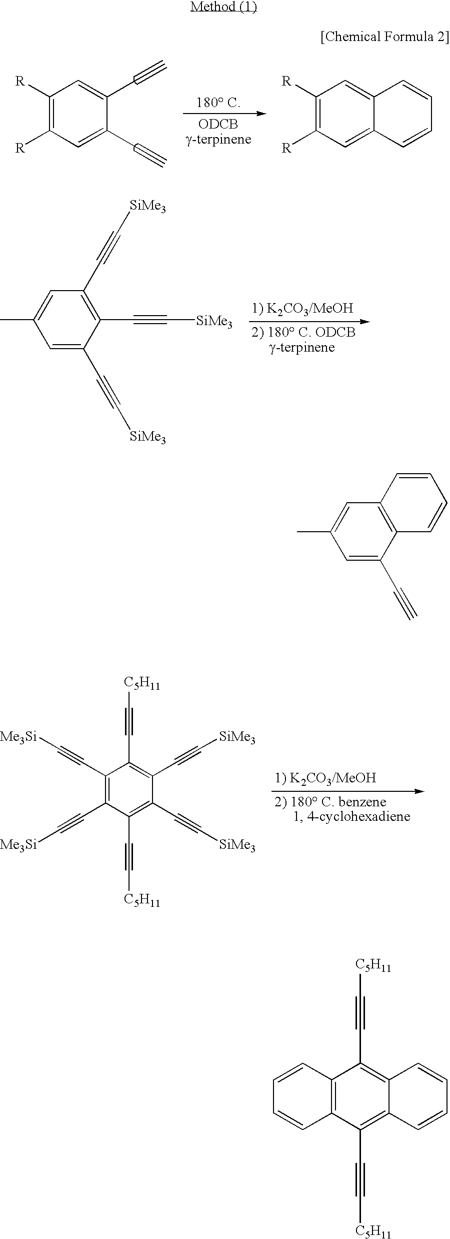

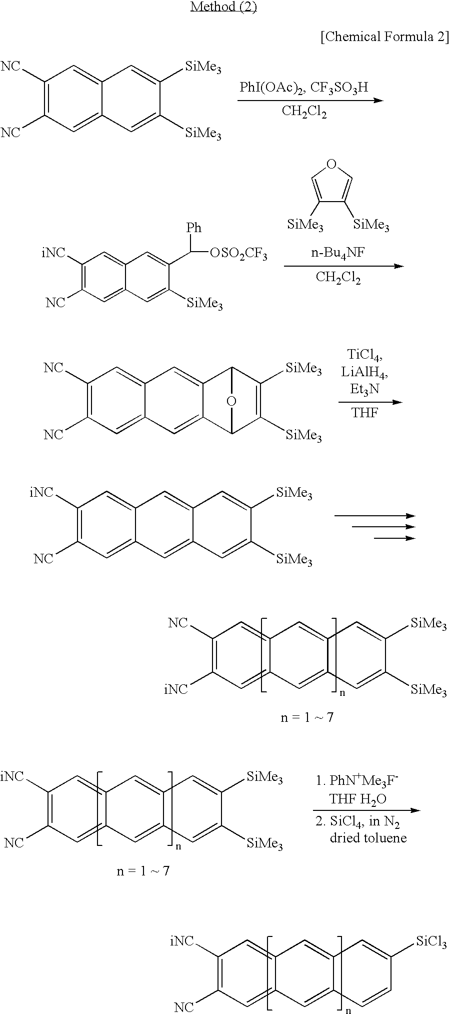

In the above-mentioned method (2), since the benzene ring of the acene skeleton is increased one by one, even when a functional group having low reactivity or a protective group is contained in predetermined positions of a raw material compound, an organic silicon compound can be synthesized in the same manner. The example of this case is shown below.

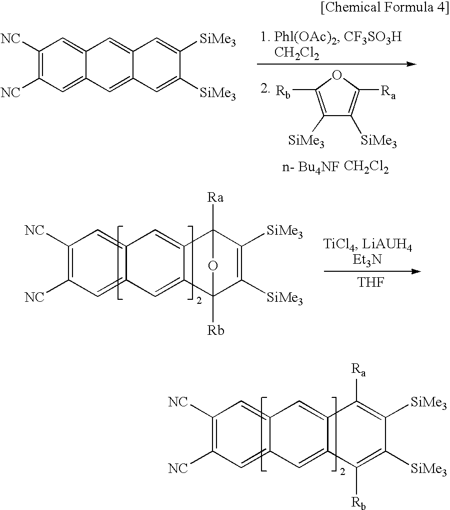

Here, each of Ra and Rb is prefered as a functional group having low reactivity, such as a hydrocarbon group and an ether group, or a protective group.

Moreover, in the reaction formula of the above-mentioned method (2), the starting compound having two acetonitrile groups and trimethylsilyl groups may be changed to a compound in which all the groups are constituted by trimethylsilyl groups. Furthermore, in the above-mentioned reaction formula, after the reaction using a furan derivative, the reaction product may be refluxed in the presence of lithium iodinate and DBU (1,8-diazabicyclo[5.4.]undese-7-ene) so that a compound in which the number of benzene rings is greater than that of the starting compound by one with two hydroxyl groups being substituted can be obtained. By brominating the hydroxyl groups of this compound using a known method, the bromo group is subjected to Grignard reaction so that a hydrophobic group can be introduced into the position of the bromo group.

The acenaphthene skeleton and perylene skeleton can be synthesized in accordance with the preparation method of the acene skeleton of the above-mentioned method (1). Examples of the preparation method are shown below:

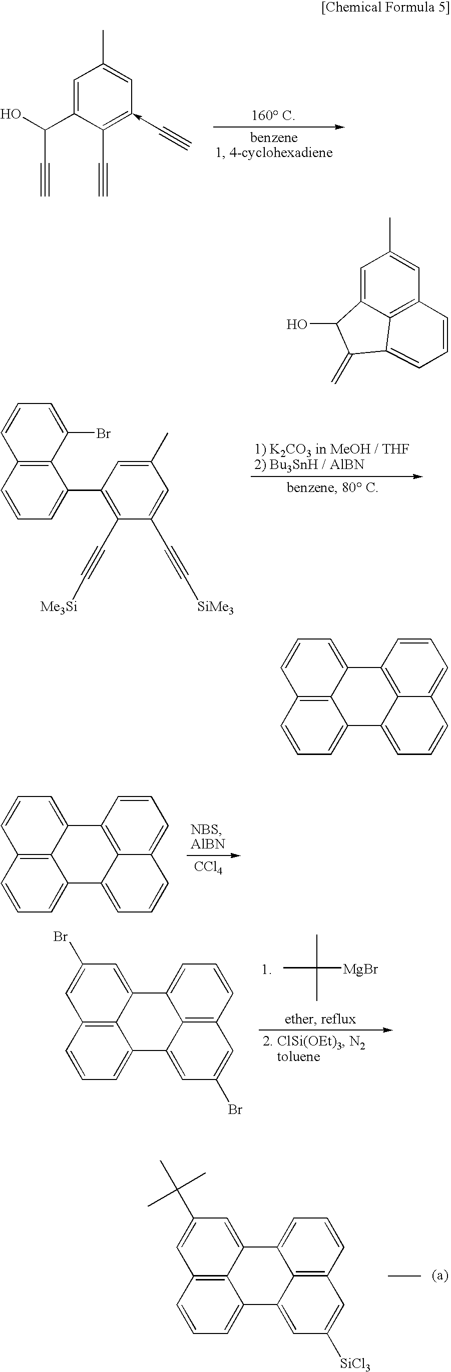

With respect to a method of inserting a secondary amino group with nitrogen atoms being substituted with two aromatic ring groups into a perylene skeleton as a side chain, a method is proposed in which, after the inserting portion of a side chain has been preliminarily halogenated, the secondary amino group is coupled in the presence of a metal catalyst. For example, in the case of the perylene molecule, the secondary amino group can be inserted by using the following method.

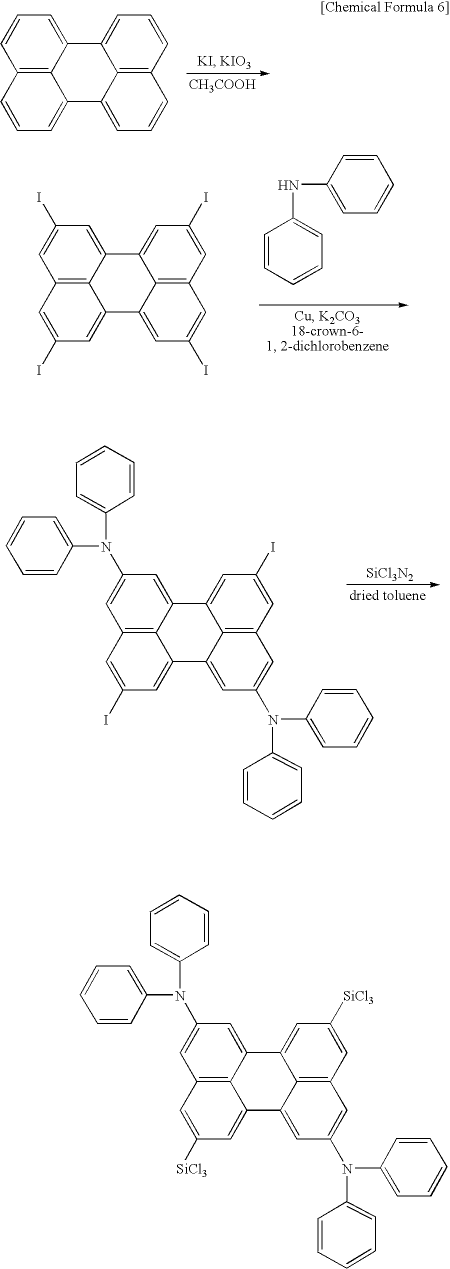

Raw materials used in the above synthesis example are general-use reagents, and can be obtained from reagent makers, and can be utilized. For example, tetracene having a purity of 97% or more can be obtained from Tokyo Kasei Kogyo Co., Ltd. Perylene having a purity of 99% can be obtained from Kishida Chemical Co., Ltd. Organic silicon compounds as obtained can be isolated and purified from a reaction solution by the known means such as transfer dissolution, concentration, solvent extraction, fractionation, crystallization, recrystallization and chromatography.

The organic silicon compound of the present invention has a structure in which a hydrophobic group and a hydrophilic group (silyl group) are bound to an acene skeleton, acenaphthene skeleton or perylene skeleton; therefore, when a thin film of the organic silicon compound is formed on a hydrophilic substrate, the hydrophilic group of the substrate is easily bound to the hydrophilic group of the compound, making it possible to improve the adsorbing property of the thin film onto the substrate. In other words, the lipophilic property or the hydrophobic property is enhanced at a portion other than a silyl group that forms a reaction site between the organic silicon compound containing π-electron conjugating molecules and the hydrophilic substrate so that the reactivity to the substrate can be improved. Moreover, by adding a hydrophobic group thereto, the solubility of the organic silicon compound to a non-aqueous solution can be improved so that the organic silicon compound is easily applied to a solution process.

With respect to the heterocyclic ring with a single ring, those containing S, N, O, Si, Ge, Se, Te, P, Sn, Ti or Zr atoms as hetero atoms with a 5-membered to 12-membered ring, more preferably, a 5-membered or 6-membered ring, are preferably used. Examples of the compound containing S, N or O atoms as hetero atoms include: a oxygen-atom containing compound such as furan, a nitrogen-atom containing compound such as pyrrole, pyridine, pyrimidine, pyrroline, imidazoline and pyrazoline, a sulfur-atom containing compound such as thiophene, a nitrogen-atom and oxygen-atom containing compound such as oxazole and isooxasole, and a sulfur-atom and nitrogen-atom containing compound such as thiazole and isothiazole, and among these, thiophene is particularly preferable. Moreover, with respect to the compound containing Si, Ge, Se, Te, P, Sn, Ti or Zr atoms as hetero atoms, for example, specific 5-membered units are the following structural units.

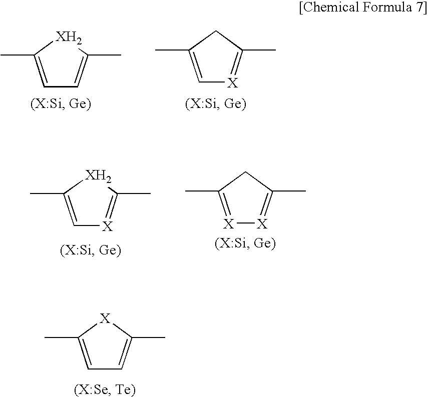

Moreover, specific 6-membered units are the following structural units.

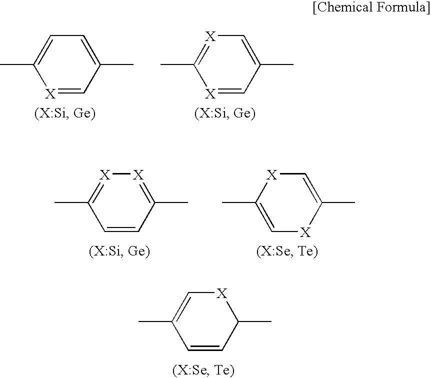

These heterocyclic compound units may have a direct or indirect bond between the same units or between different units, and one to 30 of the units are bound to form a π-electron conjugated system organic residue as a whole. Here, it is preferable that 1 to 9 of the units are bound, taking a yield, economic property and mass production into consideration. Moreover, the heterocyclic compound unit may have a direct or indirect bond with an aromatic hydrocarbon compound unit. The unit of the aromatic hydrocarbon compound has the same structure as the above-mentioned condensed polycyclic hydrocarbon.

A plurality of these heterocyclic compound units may be bound in a branched manner, but may be preferably bound in a straight manner. In addition, the organic residue may comprise the same units bound with each other, units which are all different bound with one another, or a plurality of kinds of units bound with one another regularly or in a random order. In addition, positions of bonds, when a constitutional molecule of a unit is a 5-membered ring, may be any of 2,5-positions, 3,4-positions, 2,3-positions, 2,4-positions and the like, among which 2,5-positions are preferable. In the case when a heterocyclic compound with a single ring, which contains Si, Ge, Se, Te, P, Sn, Ti or Zr atoms as hetero atoms, is a 5-membered ring, the positions of bonds may be 1,1-positions in addition to the above-mentioned positions. In the case of a 6-membered ring, the positions of bonds may be any of 1,4-positions, 1,2-positions, 1,3-positions and the like, among which 1,4-positions are preferable.

Further, a vinylene group may be situated between the heterocyclic units. Examples of hydrocarbon affording a vinylene group include alkene, alkadiene and alkatriene. Examples of the alkene include a compound of a carbon number of 2 to 4 such as ethylene, propylene and butylenes. Among these, ethylene is preferable. Examples of the alkadiene include a compound of a carbon number of 4 to 6 such as butadiene, pentadiene and hexadiene. Examples of the alkatriene include a compound of a carbon number of 6 to 8 such as hexatriene, pentatriene and octatriene.

With respect to the π-electron conjugated system molecules containing a heterocyclic compound with a single ring explained above, examples thereof include the following compounds. Here, R represents any functional group as long as it reacts with a functional group sticking out of the molecular thin film formed in the first process.

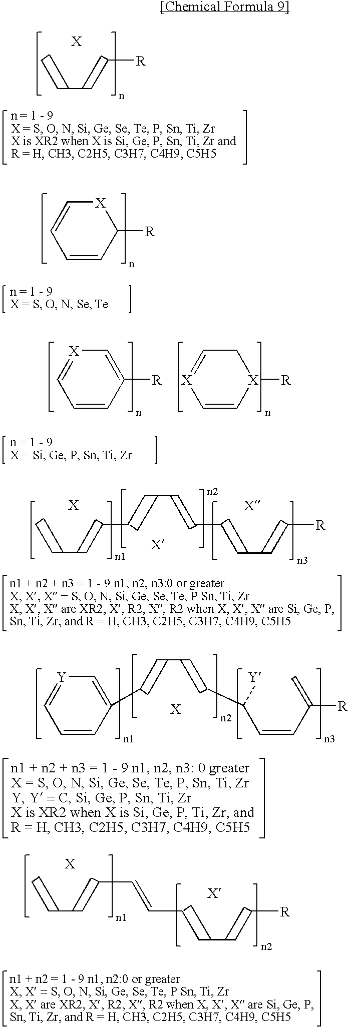

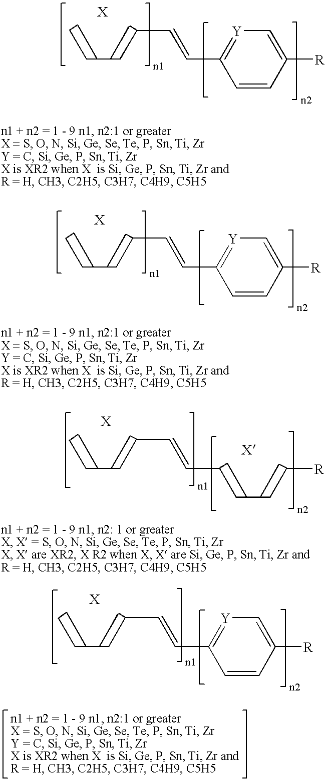

With respect to the condensed heterocyclic compounds, examples thereof include: indole, isoindole, benzofuran, benzothiophene, indolidine, chromene, quinoline, isoquinoline, purine, indazole, quinazoline, cinnoline, quinoxaline and phthalazine.

Examples of the alkene include a compound of a carbon number of 2 to 4 such as ethylene, propylene and butylene. Among these, ethylene is preferable. Examples of the alkadiene include a compound of a carbon number of 4 to 6 such as butadiene, pentadiene and hexadiene. Examples of the alkatriene include a compound of a carbon number of 6 to 8 such as hexatriene, heptatriene and octatriene.

Among these compounds, those which are preferably used as the organic compound composed of π-electron conjugated system molecules serving as main skeleton are compounds which are formed by binding 3 to 10 benzene rings or thiophene rings to one another in a straight manner.

The above description has explained the organic compound to be bound in the second process; however, with respect to the organic compound used in the second process, any one of the above-mentioned compounds may be laminated as long as it has a functional group capable of reacting with the first functional group periodically sticking out of the surface of the base.

Hereinafter, an example of synthesizing a precursor of an organic residue composed of a unit derived from a heterocyclic compound with a single ring and an example of synthesizing an organic silane compound from the precursor.

With respect to the synthesizing method of a precursor of a 5-membered ring constituted by units derived from a selenophene ring, reports have been found in Polymer, pp 5597-5603, vol. 44 (2003), and in the present invention also, the synthesizing process is carried out based upon the preparation method of the reports. Moreover, with respect to the synthesizing method of a precursor constituted by units derived from a silole ring, reports have been found in Journal of Organometallic Chemistry, pp 223-228, vol. 653 (2002), Journal of Organometallic Chemistry, pp 73-80, vol. 559 (1998) and Coordination Chemistry Reviews, pp 1-44, vol. 244 (2003), and in the present invention also, the synthesizing process is carried out based upon the preparation method of the reports. It is effective to halogenate a reaction site of selenophene (silole) and then subject it to Grignard reaction. By using this method, a precursor in which the number of selenophene rings (silole rings) is controlled can be synthesized. Alternatively, in addition to the method of applying Grignard reagent, the precursor can be also synthesized by a coupling process in which a suitable metal catalyst (Cu, Al, Zn, Zr, Sn etc.) is utilized. By utilizing the above-mentioned reaction of selenophene, the number of selenophene rings (silole rings) can be increased. A terminal of the precursor can be halogenated in the same manner as a raw material used for synthesizing it. For this reason, after having been halogenated, the resulting precursor is allowed to react with, for example, SiCl₄ so that a silicon compound, which has a silyl group at its terminal and is provided with an organic residue composed only of a unit derived from selenophene (silole) (simple selenophene or simple silole compound), is obtained.

One example of a method of synthesizing a precursor of an organic residue composed only of selenophene and one example of a method of silylating a precursor are shown in the following (A) to (C). In the following example of synthesis of a precursor composed only of selenophene rings, only a reaction from a monomer of selenophene to a dimer or a trimer thereof is shown. However, since the number of selenophene rings may be increased one by one by using this method, a tetramer or more thereof may be formed through the same processes.

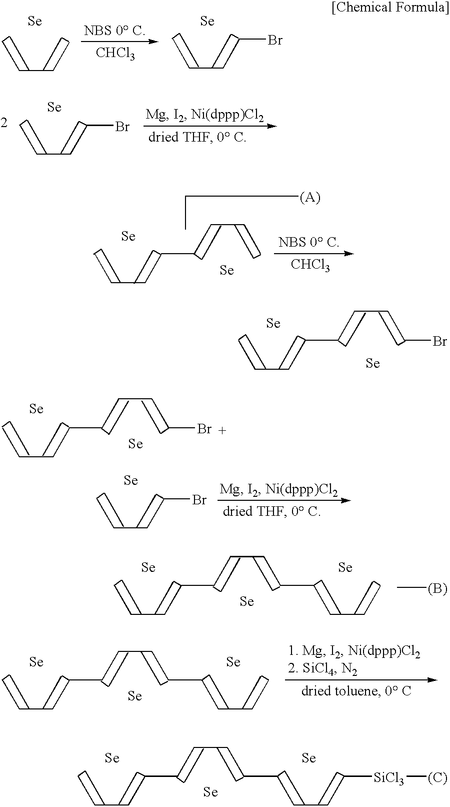

One example of a method of synthesizing a precursor of an organic residue composed only of silole and one example of a method of silylating a precursor are shown in the following (D) to (H). In the following example of synthesis of a precursor composed only of silole rings, only a reaction from a monomer of silole to a dimer or a tetramer to a hexamer thereof is shown. However, since the number of silole rings may be increased one by one by using this method, a trimer or a heptamer or more thereof may be formed through the same processes.

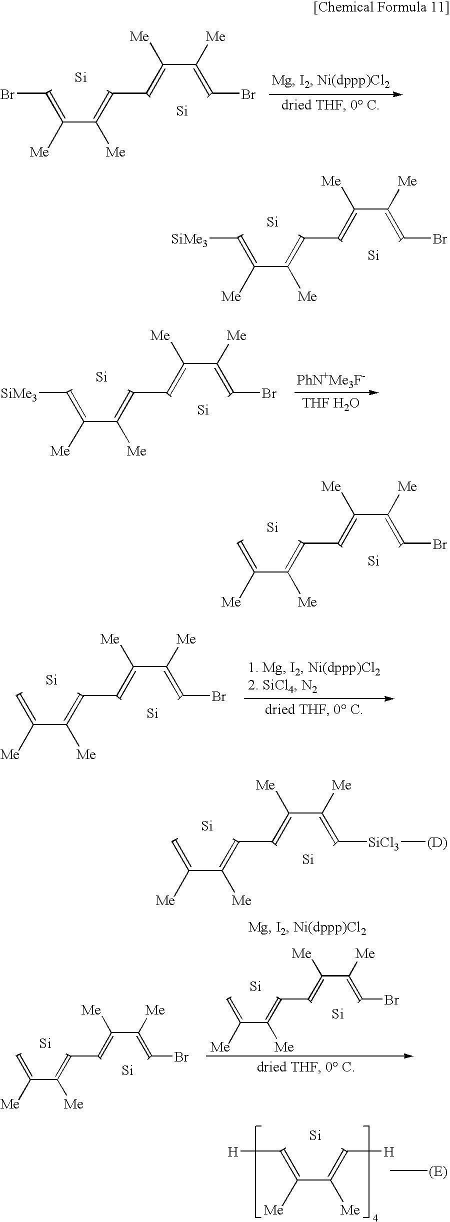

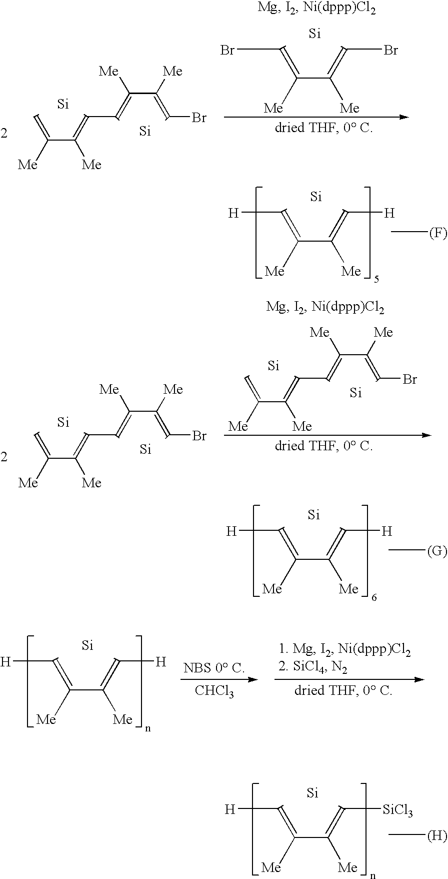

By using the same method, it is possible to synthesize an organic silane compound containing 1 to 10 units of heterocyclic compounds with a 5-membered ring, which includes Ge, Te, P, Sn, Ti or Zr atoms as hetero atoms.

With respect to a method for obtaining a precursor of a block-type organic residue in which a unit derived from heterocyclic compounds with a single ring, which includes Si, Ge, Se, Te, P, Sn, Ti or Zr atoms as hetero atoms, and a unit derived from thiophene or benzene are directly bound to each other to form units, for example, a method of using Suzuki coupling or a method of using Grignard reaction is proposed. Moreover, by allowing the precursor to react with SiCl₄ or HSi(OEt)₃, an objective silicon compound can be obtained. For example, in a synthesizing method of an organic silane compound in which units derived from thiophene or benzene are bound to the two terminals of a compound having a silole ring, first, by adding n-BuLi and B(O-iPr)₃ to the compound having a silole ring, this is debrominated and boronized. As a solvent thereupon, ether is preferable. In addition, the boronization is 2-stages where the first stage is preferably performed at −78° C. in order to initially stabilize the reaction, and the second stage is gradually elevated from −78° C. to room temperature. Next, a simple benzene compound or a simple thiophene compound having a halogen group (for example, bromo group) at its terminal and the above-mentioned boronized compound are developed, for example, in a toluene solvent, and the reaction is allowed to completely proceed at a reaction temperature of 85° C. in the presence of Pd(PPh₃)₄ and Na₂CO₃, to cause the coupling. Consequently, a silicon compound having a silyl group at a terminal of a block-type compound can be synthesized.

One example of the route for synthesizing silicon compounds (I) and (J) using such the reaction is shown below. Here, with respect to a compound containing Ge, Se, Te, P, Sn, Ti or Zr atoms as hetero atoms, the reactivity of the 2,5-positions is the same as that of silole; therefore, by using the same synthesizing methods, units each of which is formed by directly binding a compound containing Ge, Se, Te, P, Sn, Ti or Zr atoms as hetero atoms and a unit portion derived from thiophene or benzene to each other so that an organic silane compound is synthesized.

Moreover, the unit portion derived from thiophene or benzene may be the above-mentioned units derived from a heterocyclic compound containing Si, Ge, Se, Te, P, Sn, Ti or Zn atoms as hetero atoms.

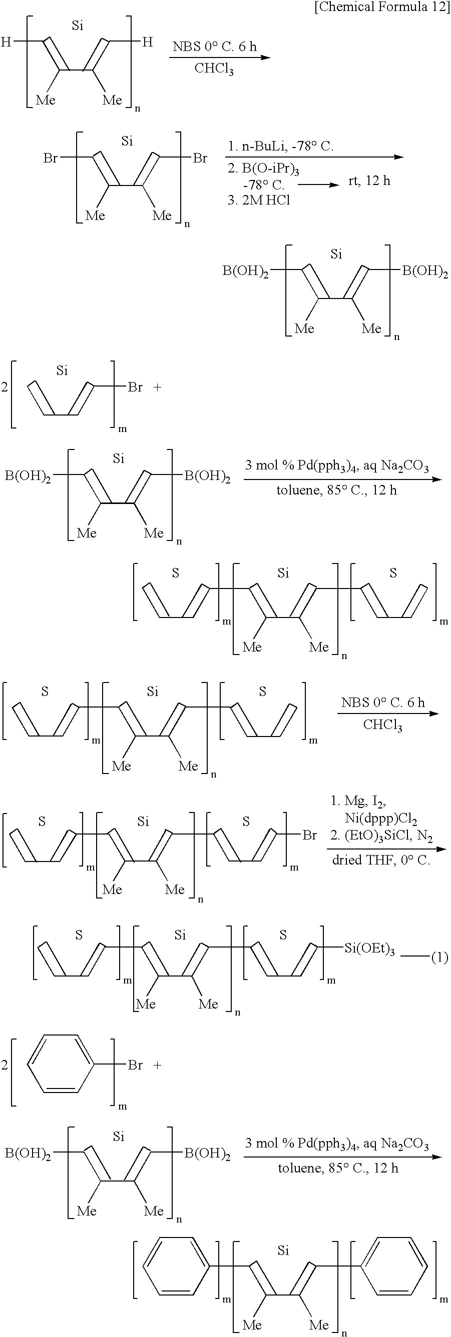

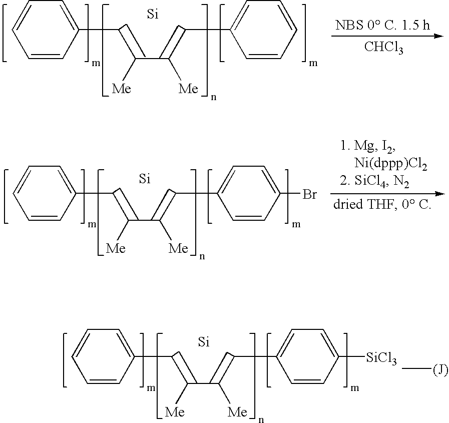

Regarding any compound, a raw material having a side chain (e.g. alkyl group) at a prescribed position can be used. That is, for example, when 2-octadecylselenophene is used as a raw material, 2-octadecylterselenophene can be obtained by the above synthesis route as a precursor (B). Therefore, as silicon compound (C), 2-octadecylterselenophenetrichlorosilane can be obtained. Similarly, when a raw material having a side chain at a prescribed position in advance is used, a compound which is any compound of (A) to (J) and has a side chain can be obtained.

In the preparation method (i) of the present invention, the reaction temperature of the first process that allows the base to react with the silane compound of the first layer and the second process that allows the second layer to react with the molecular thin film formed on the base is, for example, set to −100 to 150° C., more preferably to −20 to 100° C. The reaction time is, for example, around 0.1 to 48 hours in each of the processes. The reaction in each of the first and second processes is usually carried out in an organic solvent having no influence on the reaction. Examples of the organic solvent having no adverse influence on the reaction include hydrocarbons such as hexane, pentane, benzene and toluene; ether solvents such as diethyl ether, dipropyl ether, dioxane and tetrahydrofuran (THF); and aromatic hydrocarbons such as benzene and toluene, and these may be used alone or in a combination of them as a mixed solution. Among these, diethyl ether and THF are preferable. In the reaction, a catalyst may be optionally used. With respect to the catalyst, the known catalyst to be used in reactions of this type, such as a platinum catalyst, a palladium catalyst and a nickel catalyst, may be used.

With respect to the second functional group contained in the organic compound to be allowed to react in the second process, not particularly limited, any group may be used as long as it reacts with a sticking functional group (the first or third functional group) of the molecular thin film formed on the base, and in the same manner as the molecular thin film, various functional groups may be selected.

In the preparation method (ii) of the present invention, the reaction temperature of the first process that allows the base to react with the organic silane compound forming an insulating monomolecular film and the second process that allows π-electron conjugated system molecules to react with the insulating monomolecular film formed on the base is, for example, set to −100 to 150° C., more preferably to −20 to 100° C. The reaction time is, for example, around 0.1 to 48 hours in each of the processes. The reaction in each of the first and second processes is usually carried out in an organic solvent having no influence on the reaction. Examples of the organic solvent having no adverse influence on the reaction include hydrocarbons such as hexane, pentane, benzene and toluene; ether solvents such as diethyl ether, dipropyl ether, dioxane and tetrahydrofuran (THF); and aromatic hydrocarbons such as benzene and toluene, and these may be used alone or in a combination of them as a mixed solution. Among these, diethyl ether and THF are preferable. In the reaction, a catalyst may be optionally used. With respect to the catalyst, the known catalyst to be used in reactions of this type, such as a platinum catalyst, a palladium catalyst and a nickel catalyst, may be used.

In accordance with one aspect, the present invention provides an organic thin film transistor, comprising: a functional organic thin film formed on a surface of a substrate directly or indirectly; a gate electrode formed on the surface of the substrate indirectly or directly; a source electrode and a drain electrode formed on one surface of the functional organic thin film or on the other surface thereof; and a gate insulating film formed between the gate electrode and the source/drain electrodes, wherein the functional organic thin film has π-electron conjugated system molecules bonded to a network structure moiety via insulating molecules, the network structure moiety being formed of silicon atoms and oxygen atoms and formed on the base.

In accordance with another aspect, the present invention provides a manufacturing method of an organic thin film transistor, comprising: a step (A) for forming a functional organic thin film on a surface of a substrate directly or indirectly; a step (B) for forming a gate electrode on the surface of the substrate indirectly or directly; a step (C) for forming a source electrode and a drain electrode on one surface of the functional organic thin film or on the other surface thereof; and a step (D) for forming a gate insulating film between the gate electrode and the source/drain electrodes, wherein the step (A) includes a first step of bonding insulating molecules, having first functional groups at the terminals, to the base via a network structure moiety formed of silicon atoms and oxygen atoms and a second step of reacting second functional groups located at the terminals of π-electron conjugated system molecules to the first functional groups of the insulating molecules or third functional groups formed by converting the first functional groups so that the π-electron conjugated system molecules are bonded to the insulating molecules.

Here, the term “one surface of the functional organic thin film” indicates a face that is directed to the same direction as the surface of the substrate, and the term “the other surface of the functional organic thin film” indicates a surface (rear face) that faces in a direction opposite to the surface of the substrate.

The above-mentioned processes (A), (B), (C) and (D) are not intended to be limited by this order, and the order of the processes can be freely changed in accordance with the transistor structure to be obtained.

In accordance with the organic thin film transistor and the manufacturing method thereof of the present invention, the first layer, which forms a functional organic thin film corresponding to an organic semiconductor layer, has a periodic structure in a molecular level, and features that the second layer is formed thereon. Therefore, different from an organic thin film constituted only by π-electron conjugated system molecules, the influences from repulsion among π-electrons are made smaller so that a densely packaged structure is obtained; thus, it becomes possible to provide an organic thin film transistor having superior performances in both of the mobility and on/off ratio.

The organic thin film transistor of the present invention can take various forms such as a staggered type, a reverse staggered type and a variation thereof. For example, in the case of the staggered type, examples include a form in which a functional organic thin film is formed on a substrate, a gate electrode is arranged thereon via a gate insulating film, and source/drain electrodes, which are separated from the gate electrode, are placed on both sides of the gate electrode and are in contact with the functional organic thin film. Moreover, another form may be used in which: a gate electrode is formed on a substrate, a functional organic thin film is formed on a gate electrode via a gate insulating film, and source/drain electrodes in contact with the organic thin film are arranged on the organic thin film so that they are not overlapped with the gate electrode. In addition, still another form may be used in which: a gate electrode is formed on a substrate, a gate insulating film is formed on the gate electrode, source/drain electrodes are formed on the gate insulating film so that they are not overlapped with the gate electrode, and a functional organic thin film is formed between the source electrode and the drain electrode on the substrate.

With respect to the substrate, the same material as that of the above-mentioned base to be used for preparing the functional organic thin film of the present invention can be used.

Examples of the gate insulating film normally include an insulating film used in a transistor; that is, insulating films such as silicon oxide film (thermal oxidized film, low temperature oxidized film: LTO film, high temperature oxidized film: HTO film), silicon nitride film, SOG film, PSG film, BSG film and BPSG film; PZT, PLZT, ferroelectric or antiferroelectric film; low dielectric film such as SiOF-based film, SiOC-based film or CF-based film, HSQ (hydrogen silsesquioxane)-based film (inorganic-based) formed by applying, MSQ (methyl silsesquioxane)-based film, PAE (polyarylene ether)-based film, BCB-based film, porous-based film or CF-based film, or porous films. The film thickness of the gate insulating film is not particularly limited, but usually can be appropriately adjusted to a film thickness used in a transistor.

The gate electrode and source/drain electrodes can be usually formed with an electric conductive material used in a transistor. Examples of the electric conductive material include a monolayer or a laminated layer of metals such as gold, platinum, silver, cupper and aluminum; high melting point metals such as titanium, tantrum and tungsten; silicide or polycide with high melting point metals. The film thickness of each of the gate electrode and source/drain electrodes is not particularly limited, but usually can be appropriately adjusted to a film thickness used in a transistor.

The organic thin film transistor of the present invention can be applied to a variety of utilities, as semiconductor devices such as a memory, a logic element and a logic circuit, in electronic devices: e.g., data processing systems such as computer systems of personal computer, notebook, laptop, personal-assistant/communicator, minicomputer, work station, main frame, multiprocessor-computer and other all types; electron parts constituting data processing systems such as CPU, memory and data memory device; communication equipment such as telephone, PHS, modem and router; image display equipment such as display panel and projector; office work equipment such as printer, scanner and copying machine; sensor; image pickup equipment such as video camera and digital camera; leisure equipment such as gaming machine and music player; information equipment such as portable information terminal, clock and electronic dictionary; car packaging equipment such as car navigation system and car audio; AV equipment for recording and reproducing information such as animation, still picture and music; electric appliances such as washing machine, microwave oven, refrigerator, rice cooker, dish washer, vacuum cleaner and air conditioner; health managing equipment such as massage equipment, scales and tonometer; portable-memory devices such as IC card and memory card.

Referring to Figures, the following description will discuss Embodiments of the present invention. However, the present invention is not intended to be limited by these Embodiments.

### Embodiment 1

### Formation of Molecule Thin Film+Lamination of π-Electron Conjugated System Molecule Thin Film

The present Embodiment 1 relates to a manufacturing method of a functional organic thin film in which an O—Si—O network used for regularly forming an organic thin film closely adhered to a substrate is formed, and a functional group sticking out of Si and a π-electron conjugated system molecule are formed so as to obtain the functional organic thin film, and also concerns such a film.

FIG. 1(a) to 1(c) are conceptual diagrams in molecule level, which show manufacturing method (i) of the functional organic thin film of the present invention. FIG. 1(a) shows a first process, FIG. 1(b) shows a second process, and FIG. 1(c) shows a functional organic thin film formed on the substrate.

As shown in FIG. 1(c), the present invention features a functional organic thin film 5 having desired functions, formed on a desired base such as a surface of a substrate 1, and this functional organic thin film 5 is constituted by a network structure film moiety 3a serving as a first layer, which is combined with the surface of a base 1, and an organic film portion 4b serving as a second film which is periodically arranged on a surface of the network structure film moiety 3a.

In the manufacturing method of the functional organic thin film of the present invention, as shown in FIG. 1(a), first, for example, a silane compound 2 is allowed to react with the substrate 1 (for example, quartz) by using a chemical adsorption method in a first process. After the reaction, as shown in FIG. 1(b), silicon atoms and oxygen atoms are combined with each other to form a network pattern on the surface of the base 1, with functional groups R1 periodically sticking out, so that a molecular thin film 3 having a self-organizing function is formed. Successively, in a second process, an organic compound having a functional group R2 that is allowed to react with the functional group R1, for example, an organic compound 4, composed of π-electron conjugated system molecules 4a serving as its main skeleton, is allowed to react by using a chemical adsorption method so that the organic compound 4 is chemically bonded onto the molecular thin film 3 having the network structure; thus, as explained by FIG. 1(c), a functional organic thin film 5, composed of a network structure film moiety 3a and an organic film portion 4b having a structure in which π-electron conjugated system molecules 4a are periodically arranged on the network structure film moiety 3a, is formed.

The following description will discuss Examples 1 to 8 of a functional organic thin film which is obtained by forming an O—Si—O network used for regularly forming an organic thin film adhered to a substrate as well as forming functional groups, each sticking out of Si, and π-electron conjugated system molecules, and a manufacturing method (i) thereof.

### EXAMPLE 1

### Formation of Molecular Thin Film Using Vinyltrichlorosilane, Conversion to Carboxy-Terminal Molecular Thin Film and Formation of Functional Organic Thin Film Containing Terthiophene, Using Molecular Thin Film

Referring to FIGS. 2(a) to 2(c), the following description will discuss a preparation method of a functional organic thin film containing terthiophene, which is Example 1 of the preparation method of the present invention. FIGS. 2(a) to 2(c) are conceptual diagrams in molecule level that show respective processes for forming the functional organic thin film containing terthiophene. FIG. 2(a) shows a molecular thin film formed in the first process, FIG. 2(b) shows a state in which the functional group of the molecular thin film is converted to another functional group, and FIG. 2(c) shows a functional organic thin film formed in the second process.

First, a quartz substrate 1 was immersed in a mixed solution (mixing ratio: 3:7) of hydrogen peroxide and concentrated sulfuric acid for one hour so that the surface of the quartz substrate 1 was hydrophilization-treated. Thereafter, under an inert atmosphere, the resulting substrate 1 was immersed for 5 minutes in a solution prepared by dissolving 10 mM vinyltrichlorosilane in a non-aqueous solvent (e.g. n-hexadecane), slowly pulled up and washed with a solvent so that as shown in FIG. 2(a), a molecular thin film in which a network structure film moiety 3a, which was made from silicon atoms and oxygen atoms combined with the quartz substrate 1 and vinyl groups periodically sticking out from the surface of the network structure film moiety 3a, was formed.

The quartz substrate 1 on which the molecular thin film 3 was formed was measured by an infrared absorption spectrometer so that the absorption derived from C—H expansion vibration at wavelength of 3090 cm⁻¹ was observed.

Next, the resulting molecular thin film 3 was oxidized in the presence of, for example, potassium permanganate, and periodic acid was then added thereto, and the resulting product was washed with a solvent so that as shown in FIG. 2(b), a molecular thin film 3A in which carboxyl groups periodically sticking out from the surface of the network structure film moiety 3a was formed.

The quartz substrate 1 on which the molecular thin film 3A was formed was measured by an infrared absorption spectrometer so that the absorption derived from a carboxyl group at wavelength of 2450 to 3200 cm⁻¹ was observed; thus, it was confirmed that the functional groups sticking out of the substrate 1 were converted from vinyl groups to carboxyl groups.

Moreover, the molecular thin film 3A in which the vinyl groups were converted to carboxyl groups as described above was immersed for 2 hours in a solution prepared by dissolving 10 mM aminoterthiophene in a non-aqueous solvent (for example, toluene), slowly pulled up and washed with a solvent so that as shown in FIG. 2(c), a terthiophene monomolecular film 4b serving as an organic film portion was formed on the network structure film moiety 3a; thus, a functional organic thin film 5 was obtained.

The quartz substrate 1 on which the functional organic thin film 5 was formed was measured by an ultraviolet-visible absorption spectrometer so that the absorption at a wavelength of 360 nm, derived from the absorption wavelength of terthiophene serving as a π-electron conjugated system molecule, was detected. Moreover, from measurement of a film thickness by ellipsometry, the result of 1.5 nm corresponding to a molecular length was obtained. Thus, it was confirmed that a monomolecular film containing terthiophene serving as π-electron conjugated system molecules was formed on the quartz substrate 1 through a network in which silicon atoms and oxygen atoms were arranged in a network structure.

### EXAMPLE 2

### Formation of Functional Organic Thin Film Containing Terphenyl by Utilizing Carboxy Terminal Molecular Thin Film

A molecular thin film 3A having a carboxyl group, prepared by using the same method as Example 1 (see FIG. 2(b)), was immersed for 2 hours in a solution prepared by dissolving 10 mM terphenyl trichlorosilane in a non-aqueous solvent (for example, n-hexadecane), slowly pulled up and washed with a solvent so that a terphenyl monomolecular film was formed on the molecular thin film; thus, a functional organic thin film 5 was obtained.

The quartz substrate on which the functional organic thin film was formed was measured by an ultraviolet-visible absorption spectrometer so that the absorption at a wavelength of 270 nm, derived from the absorption wavelength of terphenyl serving as a π-electron conjugated system molecule, was detected. Moreover, from measurement of a film thickness by ellipsometry, the result of 1.6 nm corresponding to a molecular length was obtained. Thus, it was confirmed that a monomolecular film containing terphenyl serving as π-electron conjugated system molecules was formed through a network in which silicon atoms and oxygen atoms were arranged in a network structure on the quartz substrate 1.

### EXAMPLE 3

### Conversion of Carboxy-Terminal Molecular Thin Film to Amino-Terminal Molecular Thin Film and Formation of Functional Organic Thin Film Containing Octadecane, Using Amono-Terminal Molecular Thin Film

In a molecular thin film 3A having a carboxyl group (see FIG. 2(b)) that was prepared by using the same method as Example 1, the carboxyl group was converted to an amino group by utilizing acylation and Hofmann decomposition reaction in SOCl₂. Here, Hofmann decomposition reaction is a known synthesis technique in which a compound having an acyl group is successively subjected to NH₃ and OBr treatments so that the acyl group is converted into an amide group (R—CONH₂) and an amino group.

The molecular thin film was immersed for 2 hours in a solution prepared by dissolving 10 mM stearic acid in a non-aqueous solvent (for example, toluene), slowly pulled up and washed with a solvent so that an octadecane monomolecular film was formed on the molecular thin film through amide bond.

The quartz substrate on which the octadecane monomolecular film was formed was measured by an infrared absorption spectrometer so that the absorption derived from amide group at wavelength of 1690 cm⁻¹ as well as at wavelength of 1540 cm⁻¹ was observed. This indicates that the amide bond is contained in the film, and it was confirmed that stearic acid was bonded onto the substrate. Moreover, in X-ray diffraction measurement, a peak was confirmed at 2θ=21.3° so that the formation of a crystalline film with an interplanar spacing of 0.416 nm was confirmed. Thus, it was confirmed that a monomolecular film containing octadecane was formed through a network in which silicon atoms and oxygen atoms were arranged in a network structure on the quartz substrate.

### EXAMPLE 4

### Formation of Functional Organic Thin Film Containing Quarterphenyl Using Amino-Terminal Molecular Thin Film, and Measurement of Electric Conductivity in Film Thickness Direction of Functional Organic Thin Film

A Si substrate to which a conductive property (0.1 to 0.2 Ω·cm) had been applied through high-doping was immersed in a mixed solution (mixing ratio: 3:7) of hydrogen oxide and concentrated sulfuric acid for one hour so that the surface of the substrate was hydrophilization-treated.

An ethoxytrichlorosilane molecular thin film was formed on this Si substrate by using the same method as Example 3, and a functional organic thin film containing quarterphenyl was then formed thereon by using 1-acylquarterphenyl through the same method as Example 2.

Electric conductivity in a film thickness direction of the monomolecular thin film (direction vertical to substrate) was measured using SPM (scanning type probe microscope) and, as a result, a high value of 10⁻⁴ S/cm was obtained.

### EXAMPLE 5

### Formation of Functional Organic Thin Film Containing Quarterphenyl Using Amino-Terminal Molecular Thin Film, and Measurement of Electric Conductivity in Plane Direction of Functional Organic Thin Film

On a quartz substrate having a functional organic thin film containing quarterphenyl prepared in Example 4, a pair of electrode terminals were formed through Au vapor deposition. Thereafter, a direct-current power source used for applying a predetermined voltage across the two terminals and an ampere-meter conductivity measuring means used for detecting a current between the two terminals were installed.

Electric conductivity of the functional organic thin film containing quarterphenyl was measured and, as a result, a value of 10⁻⁶ S/cm was obtained. Moreover, as a result of measurement on mobility by using a TOF method (Time of Flight Method), a value of 0.1 cm²/V·s was obtained. From these results, it is clearly found that this functional organic thin film has superior semiconductor characteristics in the plane direction (direction in parallel with the film).

### EXAMPLE 6

### Formation of Functional Organic Thin Film Containing Anthracene Utilizing Carboxy-Terminal Molecular Thin Film

A quartz substrate on which a molecular thin film having a carboxyl group was formed, prepared by the same method as Example 1, was immersed in 20 minutes in a 2 mM 1-aminoanthracene solution, pulled up and then washed with a solvent so that a monomolecular film containing anthracene was formed on a molecular foil film. The ultraviolet-visible absorption of the quartz substrate was 360 nm that virtually corresponded to the absorption of anthracene. As a result of IR evaluation on the quartz substrate, an absorption of 1650 cm⁻¹ derived from NHCO was observed. Thus, it was confirmed that the amide bond was formed. Thus, it was confirmed that an organic thin film containing anthracene was formed on the quartz substrate through a network organization of silicon atoms and oxygen atoms.

### EXAMPLE 7

### Formation of Functional Organic Thin Film Containing Perylene Utilizing Carboxy-Terminal Molecular Thin Film

First, 1 mM perylene was reacted with a nitration reagent (HNO₃/H₂SO₄) to prepare nitroperylene, and this was then pressurized and reduced in the presence of H₂ and Ni catalyst so that 1-aminoperylene was synthesized.

A quartz substrate on which the molecular thin film having a carboxyl group was formed, prepared by the same method as Example 1, was immersed for 30 minutes in a 5 mM solution of the above-mentioned 1-aminoperylene, pulled up and then washed with a solvent so that a monomolecular film containing perylene was formed on a molecular foil film. The ultraviolet-visible absorption of the quartz substrate containing the molecular thin film was 380 nm that virtually corresponded to the absorption of perylene. As a result of IR evaluation on the quartz substrate, an absorption of 1630 cm⁻¹ derived from NHCO was observed. Thus, it was confirmed that tire amide bond was formed. Consequently, it was confirmed that an organic thin film containing perylene was formed on the quartz substrate through a network organization of silicon atoms and oxygen atoms.

### EXAMPLE 8

### Formation of Functional Organic Thin Film Containing Diselenophene Utilizing Carboxy-Terminal Molecular Thin Film

Diselenophene can be synthesized by using a preparation method described in Polymer, pp 5597-5603, vol. 44 (2003). Here, selenophene was reacted with a nitration reagent (HNO₃/H₂SO₄) to prepare nitrodiselenophene, and this was then pressurized and reduced in the presence of H₂ and Ni catalyst so that 1-aminodiselenophene was synthesized.

A quartz substrate on which the molecular thin film having a carboxyl group was formed, prepared by the same method as Example 1, was immersed for 2 hours in a 5 mM solution of the above-mentioned 2-aminodiselenophene, pulled up and then washed with a solvent so that a monomolecular film containing diselenophene was formed on a molecular foil film. As a result of IR evaluation on the quartz substrate, an absorption of 1670 cm⁻¹ derived from NHCO was observed. Thus, it was confirmed that the amide bond was formed. Evaluations on film thickness were carried out by ellipsometry before and after the diselenophene trichlorosilane reaction so that a difference in film thickness of 0.9 nm was obtained before and after the reaction. This corresponded to the molecular length of diselenophene. Consequently, it was confirmed that an organic thin film containing diselenophene was formed on the quartz substrate through a network organization of silicon atoms and oxygen atoms.

### Embodiment 2

### Formation of Organic Silane Thin Film+Lamination of π-Electron Conjugated System Molecule Thin Film

The present Embodiment 2 relates to a functional organic thin film having an insulating molecule between a functional group sticking out of Si on an O—Si—O network and a π-electron conjugated system molecule, and also concerns a preparation method of such the film.

FIG. 3 are conceptual diagrams in molecule level, which show manufacturing method (ii) of the functional organic thin film of the present invention, FIG. 3(a) shows a first process, FIG. 3(b) shows a second process, and FIG. 3(c) shows a functional organic thin film formed on the substrate.

As shown in FIGS. 3(a) to 3(c), the present invention features a functional organic thin film 16 having desired functions, formed on a desired base such as a substrate 11, and this functional organic thin film 16 is constituted by an insulating monomolecular film 14 formed by a layer-shaped network structure moiety 12 bonded to the surface of the substrate 11 and a layer-shaped insulating portion 13 formed by a plurality of insulating molecules 13a that are bonded to the surface of the network structure moiety 12 as side chains and a conductive layer made from π-electron conjugated system molecules 15a that are bonded to the respective insulating molecules 13a of the insulating monomolecular film 14, which are laminated thereon.

In the manufacturing method of the functional organic thin film of the present invention, as shown in FIG. 3(a), first, for example, an organic silane compound 17, which has the insulating molecules 13a as organic residues with a first functional group R3 at its terminal, is allowed to react with the substrate 11 (for example, quartz) by using a chemical adsorption method in a first process. After the reaction, as shown in FIG. 3(b), a self-organizing insulating monomolecular film 14 is formed by the network structure moiety 12 in which silicon atoms and oxygen atoms are firmly combined with the surface of the substrate 11 in a network state and an insulating portion 13 formed by a plurality of insulating molecules 13a that are periodically arranged on the surface of the network structure moiety 12. First functional groups R3 are periodically arranged on the surface of the insulating monomolecular film 14 as side chains.

Next, in a second process, the first functional group R3 on the surface of the insulating monomolecular film 14 is allowed to react with an organic compound 18 that has a second functional group R4 capable of reacting with the first functional group R3 at its terminal, and is provided with π-electron conjugated system molecules 15a made of a plurality of π-electron conjugated system molecule units, for example, by a chemical adsorption method. As shown in FIG. 3(c), through this reaction, the π-electron conjugated system molecules 15a are bonded to the respective insulating molecules 13a of the insulating monomolecular 14 to form a conductive film 15 on the insulating monomolecular film 14 so that a functional organic thin film 16, which is constituted by the insulating monomolecular film 14 and the conductive film 15 that are accumulated on the substrate 11, is obtained.

As Examples other than the above-mentioned Examples 1 to 8, the following description will discuss Synthesis Examples 1 to 4 and Examples 9 to 12 that relate to a functional organic thin film having the structure of Embodiment 2 in which an insulating molecule is placed between a functional group sticking out of Si on an O—Si—O network and a π-electron conjugated system molecule, and also concern an organic thin film transistor and a manufacturing method (ii) of those.

### SYNTHESIS EXAMPLE 1

### Synthesis of terselenophenetrichlorosilane (Grignard Method)

Diselenophene can be synthesized by using a preparation method described in Polymer, pp 5597-5603, vol. 44 (2003). The following description will discuss a preparation method of terselenophenetrichlorosilane in which selenophene is used. In the same manner as the preparation method of diselenophene, first, in a 100 ml round-bottom flask were put 50 ml of chloroform and 70 mM of diselenophene, and to this was added 70M of N-bromosuccinimide (NBS) serving as a halogenating agent at a temperature of 0° C. and stirred for one hour. After having been extracted by pure water, the resulting product was refined at 80° C. under reduced pressure to obtain 2-bromodiselenophene (yield: 50%). Next, 5 ml of dried tetrahydrofuran (THF) and 7 mM of 2-bromoselenophene that is an intermediate of the synthesis of diselenophene were put in a 50 ml round-bottom flask under the nitrogen atmosphere, and to this was added magnesium, and then stirred for 2 hours. Thereafter, to this was added 5 ml of dried THF containing Ni(dppp)Cl₂(dichloro[1,3-bis(diphenylphosphono)propane]nickel (II)) serving as a catalyst and 3 ml of 2-bromodiselenophene, and allowed to react at 0° C. for 12 hours. After having been extracted by pure water, the resulting product was refined through flash chromatography to obtain terselenophene (30%). Moreover, in a 100 ml round-bottom flask were put 50 ml of chloroform and 5 mM of terselenophene, and to this was added 20M of NBS at a temperature of 0° C. and stirred for one hour. After having been extracted by pure water, the resulting product was refined at 80° C. under reduced pressure to synthesize 2-bromoterselenophene. Moreover, after 5 ml of dried THF, 2-bromoterselenophene and magnesium had been put in a 200 ml round-bottom flask in the nitrogen atmosphere, this was stirred for 2 hours to prepare a Grignard reagent.

In a 200 ml round-bottom flask equipped with a stirrer, a reflux condenser, a thermometer and a dropping funnel, 20 mM of SiCl₄ (tetrachlorosilane) and 50 ml of toluene were put and cooled with ice, to which the Grignard reagent was dropwise added at an internal temperature of 20° C. or lower over 2 hours, and after the dropping had been completed, the mixture was aged at 30° C. for one hour (Grignard reaction).

Then, the reaction solution was filtered under reduced pressure to remove magnesium chloride, and toluene and unreacted tetrachlorosilane were stripped from the filtrate, and the resulting solution was distilled to obtain terselenophenetrichlorosilane at a yield of 40%.

The resulting compound was confirmed to contain SiC bond, by its infrared absorption spectrum which showed the absorption derived from SiC at 1080 cm⁻¹.

Further, nuclear magnetic resonance (NMR) of the compound was measured. Since it is impossible to directly measure NMR of the resulting compound due to high reactivity of the compound, the compound was reacted with ethanol (generation of hydrogen chloride was confirmed) for converting terminal chlorine atom into ethoxy group and then was measured.

7.7 ppm(s) (1H aromatic-derived)

7.2 ppm to 7.1 ppm (m) (6H aromatic-derived)

3.8 ppm to 3.7 ppm (m) (6H ethoxy group-ethyl group-derived)

1.30 ppm to 1.20 ppm (m) (9H ethoxy group-methyl group-derived)

From these results, it was confirmed that the resulting compound is terselenophenetrichlorosilane.

### SYNTHESIS EXAMPLE 2

### Synthesis of Octiselenophene Triethoxysilane

Octiselenophenetriethoxysilane was synthesized by using the following method. First, 5 ml of dried THF and 5 mM of 2-bromoselenophene that is an intermediate of Synthesis Example 1 were put in a 50 ml round-bottom flask under the nitrogen atmosphere, and to this was added magnesium, and then stirred for 2 hours. Thereafter, to this was added 5 ml of dried THF containing Ni(dppp)Cl₂ serving as a catalyst and 5 ml of 2-bromodiselenophene, and allowed to react at 0° C. for 10 hours. After having been extracted by pure water, the resulting product was refined through flash chromatography to obtain quarterselenophene (35%). Moreover, in a 100 ml round-bottom flask were put 50 ml of chloroform and 70 mM of quarterselenophene that is an intermediate of Synthesis Example 2, and to this was added 70M of NBS at a temperature of 0° C. and stirred for one hour. After having been extracted by pure water, the resulting product was refined at 80° C. under reduced pressure to prepare 2-bromoquaterselenophene (yield: 40%).

Successively, 5 ml of dried THF and 5 mM of 2-bromoquaterselenophene were put in a 50 ml round-bottom flask under the nitrogen atmosphere, and to this was added magnesium, and then stirred for 3 hours. Thereafter, to this was added 5 ml of dried THF containing Ni(dppp)Cl₂ serving as a catalyst and 5 ml of 2-bromoquaterselenophene, and allowed to react at 0° C. for 12 hours. After having been extracted by pure water, the resulting product was refined through flash chromatography to obtain octiselenophene (30%). Successively, after 5 ml of dried THF, 2-bromooctiselenophene and magnesium had been put in a 200 ml round-bottom flask in the nitrogen atmosphere, this was stirred for 2 hours to prepare a Grignard reagent. Moreover, in a 100 ml round-bottom flask equipped with a stirrer, a reflux condenser, a thermometer and a dropping funnel, 10 mM of triethoxychlorosilane and 30 ml of toluene were put, and after having been cooled with ice, to this was added the Grignard reagent over two hours, and after the dropping had been completed, the mixture was aged at 30° C. for one hour (Grignard reaction).

Then, the reaction solution was filtered under reduced pressure to remove magnesium chloride, and toluene and unreacted triethoxychlorosilane were stripped from the filtrate, and the resulting solution was distilled to obtain octiselenophenetrimethoxysilane at a yield of 35%.

The resulting compound was confirmed to contain SiC bond, by its infrared absorption spectrum which showed the absorption derived from SiC at 1080 cm⁻¹.

Further, nuclear magnetic resonance (NMR) of the compound was measured.

7.7 ppm(s) (1H aromatic-derived)

7.2 ppm to 7.1 ppm (m) (16H aromatic-derived)

3.8 ppm to 3.7 ppm (m) (6H ethoxy group-ethyl group-derived)

1.3 ppm to 1.2 ppm (m) (9H ethoxy group-methyl group-derived)

From these results, it was confirmed that the resulting compound is octiselenophenetrimethoxysilane.

Here, with respect to the silole compound, the synthesizing process was carried out based upon preparation methods described in Journal of Organometallic Chemistry, pp 223-228, vol. 653 (2002), Journal of Organometallic Chemistry, pp 73-80, vol. 559 (1998) and Coordination Chemistry Reviews, pp 1-44, vol. 244 (2003).

### SYNTHESIS EXAMPLE 3

### Synthesis of Organic Silane Compound Having Six Silole Rings Indicated by Structural Formula (H) with n=6

The above-mentioned compound was synthesized by the following processes. First, 5,5′-dibromo-3,4,3′,4′-tetramethyl-1H,1H′-[2,2′]bisilolyl was synthesized based upon a preparation method described in Coordination Chemistry Reviews, pp 1-44, vol. 244 (2003) (yield: 25%). Successively, after 5 ml of dried THF, 5 mM of the above-mentioned 5,5′-dibromo-3,4,3′,4′-tetramethyl-1H,1H′-[2,2′]bisilolyl and magnesium had been put in a 200 ml round-bottom flask in the nitrogen atmosphere, this was stirred for 5 hours to prepare a Grignard reagent. Successively, in a 100 ml round-bottom flask equipped with a stirrer, a reflux condenser, a thermometer and a dropping funnel, 10 mM of 5-bromo-3,4,3′,4′-tetramethyl-1H,1H′-[2,2′]bisilolyl and 30 ml of THF were put, and after having been cooled with ice, to this was added the Grignard reagent and allowed to react at 0° C. for 15 hours. After having been extracted by pure water, the resulting product was refined by flash chromatography to synthesize an intermediate G.

Successively, after 5 ml of dried THF, 5 mM of the above-mentioned intermediate G and magnesium had been put in a 200 ml round-bottom flask in the nitrogen atmosphere, this was stirred for one hour to prepare a Grignard reagent. In a 100 ml round-bottom flask equipped with a stirrer, a reflux condenser, a thermometer and a dropping funnel, 5 mM of tetrachlorosilane and 30 ml of THF were put, and after having been cooled with ice, to this was added the Grignard reagent, and the mixture was aged at 30° C. for an hour.

Then, the reaction solution was filtered under reduced pressure to remove magnesium chloride, and THF and unreacted tetrachlorosilane were stripped from the filtrate to obtain the title compound at a yield of 20%.

Further, nuclear magnetic resonance (NMR) of the compound was measured. Since it is impossible to directly measure NMR of the resulting compound due to high reactivity of the compound, the compound was reacted with ethanol (generation of hydrogen chloride was confirmed) for converting terminal chlorine atom into ethoxy group and then was measured.

4.4 ppm(m) (1H silole-ring-derived)

3.8 ppm to 3.7 ppm (m) (6H ethoxy group-ethyl group-derived)

2.1 ppm to 2.0 ppm (m) (36H silole-ring-derived)

1.5 ppm to 1.4 ppm (m) (9H ethoxy group-methyl group-derived)

From these results, it was confirmed that the resulting compound is an organic silane compound having six silole rings indicated by structural formula (H) with n=6.

### SYNTHESIS EXAMPLE 4

### Synthesis of Organic Silane Compound Indicated by Structural Formula (1) with m=3 and n=2

The above-mentioned compound was synthesized by the following processes. First, in the same manner as Synthesis Example 3,5,5′-dibromo-3,4,3′,4′-tetramethyl-1H,1H′-[2,2′]bisilolyl corresponding to an intermediate was synthesized.

In a 500 ml glass flask equipped with a stirrer, a reflux condenser, a thermometer and a dropping funnel, 0.5 mM of n-butyllithium was put, and after having been cooled to −78° C., to this was added 5,5′-dibromo-3,4,3′,4′-tetramethyl-1H,1H′-[2,2′]bisilolyl by using the dropping funnel over 30 minutes to be converted to a lithium compound, and to this was then added 1.5 mM of bis(pinacolato)diboron, and an internal temperature of the container was elevated over 12 hours from −78° C. to room temperature to proceed that reaction. After the reaction having been completed, 2M hydrochloric acid was added to form a diboron compound. Moreover, the diboron compound was dissolved in a toluene solution, and the resulting solution was put in a 200 ml glass flask equipped with a stirrer, a reflux condenser, a thermometer and a dropping funnel, which contained 3 mol % Pd(PPh)₃ and a slight amount of sodium carbonate aqueous solution, and to this was added a toluene solution of 2-bromoterthiophene that had been preliminarily synthesized by using the dropping funnel, and allowed to react at 85° C. for 12 hours so that an intermediate in which the 2- and 5″-positions of silole ring were directly bonded to terthiophene was formed. Here, 2-bromoterthiophene was synthesized by the following processes. After 1 mM of terthiophene had been dissolved in carbon tetrachloride in a 100 ml glass flask equipped with a stirrer, a reflux condenser, a thermometer and a dropping funnel, NBS and 2,2′-azobisisobutyronitrile (AIBN) were added thereto, and after having been stirred for 2.5 hours, the resulting solution was filtered under reduced pressure.

Successively, after 5 ml of dried THF, 5 mM of the above-mentioned intermediate and magnesium had been put in a 200 ml round-bottom flask in the nitrogen atmosphere, this was stirred for one hour to prepare a Grignard reagent. In a 100 ml round-bottom flask equipped with a stirrer, a reflux condenser, a thermometer and a dropping funnel, 5 mM of triethoxychlorosilane and 30 ml of THF were put, and after having been cooled with ice, to this was added the Grignard reagent, and the mixture was aged at 30° C. for one hour. Then, the reaction solution was filtered under reduced pressure to remove magnesium chloride, and THF and unreacted tetrachlorosilane were stripped from the filtrate to obtain the title compound at a yield of 15%.

Further, nuclear magnetic resonance (NMR) of the compound was measured.

7.7 ppm(s) (1H thiophene-ring-derived)

7.3 ppm to 7.2 ppm (m) (12H thiophene-ring-derived)

3.7 ppm to 3.6 ppm (m) (6H ethoxy group-ethyl group-derived)

2.2 ppm to 2.1 ppm (m) (12H silole-ring-derived)

1.4 ppm to 1.3 ppm (m) (9H ethoxy group-methyl group-derived)

From these results, it was confirmed that the resulting compound is an organic silane compound indicated by structural formula (I) with m=3 and n=2.

### EXAMPLE 9

### Formation of Octadecaneterthiophene Laminated Film Using Aminooctadecyl Trichlorosilane and 1-Carboxylterthiophene

FIGS. 5(a) and 5(b) are schematic views in molecular level, which show respective processes of a functional organic thin film containing terthiophene. FIG. 5(a) shows a state in which an insulating monomolecular film is formed on a substrate, and FIG. 5(b) shows a state in which a conductive film is formed on the insulating monomolecular film.

In Example 9, first, a quartz substrate 31 was immersed in a mixed solution (mixing ratio: 3:7) of hydrogen peroxide and concentrated sulfuric acid for one hour so that the surface of the quartz substrate 31 was hydrophilization-treated. Thereafter, under an inert atmosphere, the resulting substrate 31 was immersed for 15 minutes in a solution prepared by dissolving 10 mM aminooctadecyl trichlorosilane in a non-aqueous solvent (e.g. n-hexadecane), slowly pulled up and washed with a solvent so that as shown in FIG. 5(a), an insulating portion 33 of octadecane having an amino group at its terminal was formed on the quartz substrate 31 through a network structure film moiety 32 having Si—O—Si bond to prepare an insulating monomolecular film 34.

The quartz substrate 31 on which the insulating monomolecular film 34 was formed was subjected to film-thickness measurements through ellipsometry so that a measured result of 2.72 nm corresponding to the molecular length was obtained. In addition, in infrared measurement of the monomolecular film, absorption derived from an amino group was confirmed at a wavelength of 3430 cm⁻¹ to 3360 cm⁻¹. Moreover, in X-ray diffraction measurement, a peak was confirmed at 2θ=21.3° so that the formation of a crystalline film with an interplanar spacing of 0.416 nm was confirmed. Thus, it was confirmed that a self-organized monomolecular film derived from aminooctadecyl trichlorosilane was formed on the quartz substrate 31.

Next, the insulating monomolecular film 34 formed by the above-mentioned aminooctadecyl trichlorosilane was immersed for 2 hours in a solution prepared by dissolving 10 mM 1-carboxyl terthiophene in a non-aqueous solvent (e.g. toluene), slowly pulled up and washed with a solvent so that as shown in FIG. 5(b), a conductive film 35 containing terthiophene was laminated on the insulating monomolecular film 34 containing aminooctadecane through amide bond so that an octadecane-terthiophene accumulated film 36 serving as a functional organic thin film was obtained.

The quartz substrate 31 on which the octadecane-terthiophene accumulated film 36 was formed, obtained through the above-mentioned processes, was measured by an infrared absorption spectrometer so that the absorption derived from amide group at wavelength of 1690 cm⁻¹ as well as at wavelength of 1540 cm⁻¹ was observed. This indicates that the amide bond is contained in the film. Moreover, the octadecane-terthiophene accumulated film 36 was measured by an ultraviolet-visible absorption spectrometer so that the absorption at a wavelength of 358 nm, derived from the absorption wavelength of terthiophene serving as a π-electron conjugated system molecule, was detected. The octadecane-terthiophene accumulated film 36 was subjected to film-thickness measurements through ellipsometry so that a measured result of a film thickness of 4.05 nm was obtained. This thickness corresponded to a film thickness formed when terthiophene was laminated on octadecane, and from these results, the formation of an octadecane-terthiophene laminated film 36 was confirmed.

### EXAMPLE 10

### Formation of Octadecane-Terphenyl Laminated Film Using Hydroxyloctadecyl Trichlorosilane and Terphenyl Trichlorosilane

In Example 10, first, a quartz substrate was immersed in a mixed solution (mixing ratio: 3:7) of hydrogen peroxide and concentrated sulfuric acid for one hour so that the surface of the quartz substrate was hydrophilization-treated. Thereafter, under an inert atmosphere, the resulting substrate was immersed for 15 minutes in a solution prepared by dissolving 10 mM hydroxyloctadecyl trichlorosilane in a non-aqueous solvent (e.g. n-hexadecane), slowly pulled up and washed with a solvent so that an insulating monomolecular film was formed on the quartz substrate.

The quartz substrate on which the insulating monomolecular film was formed was subjected to film-thickness measurements through ellipsometry so that a measured result of 2.7 nm corresponding to the molecular length was obtained. In addition, in infrared measurement of the monomolecular film, absorption derived from a hydroxyl group was confirmed at a wavelength of 3620 cm⁻¹. Moreover, in X-ray diffraction measurement, a peak was confirmed at 2θ=21.2° so that the formation of a crystalline film with an interplanar spacing of 0.418 nm was confirmed. Thus, it was confirmed that an insulating self-organized monomolecular film derived from hydroxyloctadecyl trichlorosilane was formed on the quartz substrate.

Next, the insulating monomolecular film formed by hydroxyloctadecyl trichlorosilane was immersed for 2 hours in a solution prepared by dissolving 10 mM terphenyltrichlorosilane in a non-aqueous solvent (e.g. toluene), slowly pulled up and washed with a solvent so that a conductive film containing terphenyl was laminated on the insulating monomolecular film containing hydroxyloctadecane through network constituted by Si and O to obtain an octadecane-terphenyl accumulated film serving as a functional organic thin film.

The quartz substrate on which the octadecane-terphenyl accumulated film was formed, obtained through the above-mentioned processes, was measured by an ultraviolet-visible absorption spectrometer so that the absorption at a wavelength of 270 nm, derived from the absorption wavelength of terphenyl serving as a π-electron conjugated system molecule, was detected. The octadecane-terphenyl accumulated film was subjected to film-thickness measurements through ellipsometry so that a measured result of a film thickness of 4.1 nm was obtained. This thickness corresponds to a film thickness formed when terphenyl was laminated on octadecane, and from these results, the formation of an octadecane-terphenyl laminated film was confirmed.

### EXAMPLE 11

### Formation of Octadecane-Terthiophene Laminated Film Using Hydroxyldodecyl Trichlorosilane and Terthiophene Trichlorosilane

In Example 11, first, a mica substrate was immersed in a mixed solution (mixing ratio: 1:4) of hydrogen peroxide and concentrated sulfuric acid for one hour so that the surface of the mica substrate was hydrophilization-treated. Thereafter, under an inert atmosphere, the resulting substrate was immersed for 15 minutes in a solution prepared by dissolving 10 mM hydroxyldodecyl trichlorosilane in a non-aqueous solvent (e.g. n-hexadecane), slowly pulled up and washed with a solvent so that an insulating monomolecular film was formed on the mica substrate.

The mica substrate on which the insulating monomolecular film was formed was subjected to film-thickness measurements through ellipsometry so that a measured result of 1.55 nm corresponding to the molecular length was obtained. In addition, in infrared measurement of the monomolecular film, absorption derived from a hydroxyl group was confirmed at a wavelength of 3610 cm⁻¹. Thus, it was confirmed that an insulating monomolecular film derived from hydroxyldodecyl trichlorosilane was formed on the mica substrate.

Next, the insulating monomolecular film formed by hydroxyldodecyl trichlorosilane was immersed for 2 hours in a solution prepared by dissolving 10 mM terthiophene trichlorosilane in a non-aqueous solvent (e.g. toluene), slowly pulled up and washed with a solvent so that a conductive film containing terthiophene was laminated on the insulating monomolecular film containing hydroxyldodecane through network constituted by Si and O to obtain a dodecane-terthiophene accumulated film serving as a functional organic thin film.

The quartz substrate on which the dodecane-terthiophene accumulated film was formed, obtained through the above-mentioned processes, was measured by an ultraviolet-visible absorption spectrometer, so that the absorption at a wavelength of 358 nm, derived from the absorption wavelength of terthiophene serving as a π-electron conjugated system molecule, was detected. The dodecane-terthiophene accumulated film was subjected to film-thickness measurements through ellipsometry, so that a measured result of a film thickness of 2.78 nm was obtained. This thickness corresponds to a film thickness formed when terthiophene was laminated on dodecane, and from these results, the formation of a dodecane-terthiophene laminated film was confirmed.

### EXAMPLE 12

### Formation of Carboxyldodecyl Trichlorosilane Monomolecular Film and Formation of Dodecane-Terthiophene Laminated Film Using 1-Carboxylterthiophene

In Example 11, first, a quartz substrate was immersed in a mixed solution (mixing ratio: 3:7) of hydrogen peroxide and concentrated sulfuric acid for one hour so that the surface of the quartz substrate was hydrophilization-treated. Thereafter, under an inert atmosphere, the resulting substrate was immersed for 15 minutes in a solution prepared by dissolving 10 mM carboxyldodecyl trichlorosilane in a non-aqueous solvent (e.g. n-hexadecane), slowly pulled up and washed with a solvent so that an insulating monomolecular film was formed on the quartz substrate.

The functional group of the insulating monomolecular film was converted from a carboxyl group to an amino group by utilizing an acylation treatment in SOCl₂ and Hofmann decomposition reaction.

Hofmann decomposition reaction is a known synthesis technique in which a compound containing an acyl group is successively subjected to NH₃ and OBr treatments so that the acyl group is converted into an amide group (R—CONH₂) and an amino group.

The quartz substrate on which the insulating monomolecular film was formed was subjected to film-thickness measurements through ellipsometry so that a measured result of 1.57 nm corresponding to the molecular length was obtained. In addition, in infrared measurement of the monomolecular film, absorption derived from a amino group was confirmed at a wavelength range from 3450 cm⁻¹ to 3350 cm⁻¹. Thus, it was confirmed that an insulating monomolecular film derived from aminododecyl trichlorosilane was formed on the quartz substrate.

Next, the insulating monomolecular film formed by aminododecyl trichlorosilane was immersed for 2 hours in a solution prepared by dissolving 10 mM 1-carboxylterthiophene in a non-aqueous solvent (e.g. toluene), slowly pulled up and washed with a solvent so that a conductive film containing terthiophene was laminated on the insulating monomolecular film containing aminododecane through ester bond to obtain a dodecane-terthiophene accumulated film serving as a functional organic thin film.

The quartz substrate on which the dodecane-terthiophene accumulated film was formed, obtained through the above-mentioned processes, was measured by an infrared absorption spectrometer so that the absorption derived from amide group at wavelength of 1690 cm⁻¹ as well as at wavelength of 1540 cm⁻¹ was observed. This indicates that the amide bond is contained in the film. Moreover, the dodecane-terthiophene accumulated film was measured by an ultraviolet-visible absorption spectrometer so that the absorption at a wavelength of 362 nm, derived from the absorption wavelength of terthiophene serving as a π-electron conjugated system molecule, was detected. The dodecane-terthiophene accumulated film was subjected to film-thickness measurements through ellipsometry so that a measured result of a film thickness of 2.81 nm was obtained. This thickness corresponds to a film thickness formed when terthiophene was laminated on dodecane, and from these results, the formation of an dodecane-terthiophene laminated film was confirmed.

### COMPARATIVE EXAMPLE 1

### Formation of Octane-Terthiophene Laminated Film Using Aminooctyl Trichlorosilane and 1-Carboxylterthiophene

In Comparative Example 1, first, a quartz substrate was immersed in a mixed solution (mixing ratio: 3:7) of hydrogen peroxide and concentrated sulfuric acid for one hour so that the surface of the quartz substrate was hydrophilization-treated. Thereafter, under an inert atmosphere, the resulting substrate was immersed for 15 minutes in a solution prepared by dissolving 10 mM aminooctyl trichlorosilane in a non-aqueous solvent (e.g. n-hexadecane), slowly pulled up and washed with a solvent so that a monomolecular film was formed on the quartz substrate.

The quartz substrate on which the monomolecular film was formed was subjected to film-thickness measurements through ellipsometry so that a measured result of a film thickness of 0.85 nm was obtained. The molecular length of octane is 1.07 nm, and this result indicates that octane molecules are bonded onto the quartz substrate in a tilted state. Moreover, no diffraction peak was obtained in X-ray diffraction. It has been generally known that, in the case of an alkyl molecule having carbon atoms of 12 or less, since interaction between molecular chains becomes smaller, the molecules do not have a highly oriented structure, and it was confirmed that the insulating octane monomolecular film formed in this test had a structure without molecular orientation.

Next, the octane monomolecular film having no molecular orientation was immersed for 2 hours in a solution prepared by dissolving 10 mM 1-carboxylterthiophene in a non-aqueous solvent (e.g. toluene), slowly pulled up and washed with a solvent so that a monomolecular film containing terthiophene was laminated on the monomolecular film containing aminooctane through ester bond to prepare an octane-terthiophene accumulated film.

The quartz substrate on which the octane-terthiophene accumulated film was formed, obtained through the above-mentioned processes, was subjected to film-thickness measurements through ellipsometry so that a measured result of a film thickness of 1.52 nm was obtained. Here, 0.67 nm, which is a value obtained by subtracting the film thickness of the octane monomolecular film, corresponds to the film thickness of the terthiophene film; however, the original molecular length of terthiophene is 1.26 nm, which indicates that the lamination process is not achieved appropriately, thereby confirming that the orienting property of the insulating film forming the base layer gives great effects to the orienting property of the laminated layer molecules.

### Embodiment 3

The present Embodiment 3 relates to an organic thin film transistor utilizing a functional organic thin film described in the above-mentioned Embodiment 2, and a manufacturing method thereof.

FIG. 4 is a conceptual diagram that shows an organic thin film transistor in molecular level of the present invention.

The organic thin film transistor is mainly constituted by a substrate 21, a functional organic thin film 16 of the present invention, a gate insulating film 23, a gate electrode 22, a source electrode 24 and a drain electrode 25.

The manufacturing method of the functional organic thin film of the present invention includes: process (A) for indirectly forming a functional organic thin film 16 on a surface of a substrate 21 (for example, silicon substrate), process (B) for directly forming a gate electrode 22 on the surface of the substrate 21, process (C) for forming a source electrode 24 and a drain electrode 25 on the other surface (rear surface) of the functional organic thin film 16 and process (D) for forming a gate insulating film 23 between the gate electrode 22 and the source electrode 24 as well as the drain electrode 25.

More specifically, upon forming the functional organic thin film 16, first, the gate electrode 22 is formed on the surface of the substrate 21 (process (B)), and the gate insulating film 23 that covers the gate electrode 22 is then formed on the substrate 21 (process (D)). Next, the source electrode 24 and the drain electrode 25 are formed on the gate insulating film 23 (process (C)), and the functional organic thin film 16 is then formed at least between the source electrode 24 and the drain electrode 25 on the substrate 21 (on the gate insulating film 23)(process (A)). Here, the functional organic thin film 16 may cover the entire portion of the source electrode 14 and the drain electrode 15.

Upon carrying out the above-mentioned process (A), the surface of the substrate 21 is hydrophilization-treated, and the substrate 21 thus hydrophilization-treated is immersed in a solution in which an organic silane compound 17 has been dissolved; thus, an insulating portion 13 made from insulating molecules 13a having a first functional group R3 at its terminal is formed on the substrate 21 through a network structure moiety 12 made from silicon atoms and oxygen atoms so that an insulating monomolecular film 14 is formed (see FIGS. 1(a) and 1(b)). Next, the substrate 21 is immersed in a solution in which an organic compound 18 made from π-electron conjugated system molecules 15a having a second functional group R4 in the terminal thereof is dissolved so that the second functional group R4 is allowed to react with the first functional group R3 of the insulating monomolecular film 14 to form a conductive film 15 in which a plurality of π-electron conjugated system molecules 15a are bonded onto the surface of the insulating monomolecular film 14 in a periodic orientation so that a functional organic thin film 16 is obtained (see FIGS. 1(b) and 1(c)).

The following description will explain Examples 13 to 15 relating to an organic thin film transistor having the structure of Embodiment 3, which has an insulating molecule between a functional group sticking out of Si on an O—Si—O network and a π-electron conjugated system molecule.

### EXAMPLE 13

### Formation of Octadecane-Terthiophene Laminated Film and Fabrication of Organic Thin Film Transistor Using Such Laminated Film

In Example 13, in order to fabricate an organic thin film transistor shown in FIG. 6, first, chromium was vapor-deposited on a silicon substrate 41, and a gate electrode 42 was then formed thereon.

Next, a gate insulating film 43 of a silicon nitride film was deposited by a plasma CVD method, followed by vapor-depositing chromium and gold successively; thereafter, a source electrode 44 and a drain electrode 45 were formed by the conventional photolithography technique.

Successively, an octadecane-terthiophene film was laminated on the resulting substrate 41 by using the same method as Example 9 so that an organic thin film transistor as shown in FIG. 6 was fabricated.

When the field-effect mobility of the resulting organic thin film transistor was evaluated by using a TOF method, a field-effect mobility of 1.3×10⁻¹ cm²/Vs was obtained. Moreover, an on/off ratio of about 6 order was obtained, thereby making it possible to provide better performances.

### EXAMPLE 14

### Formation of Octadecane-Quarterthiophene Laminated Film and Fabrication of Organic Thin Film Transistor Using Such Laminated Film

In Example 14, a gate electrode, a gate insulating film, a source electrode and a drain electrode were formed on a quartz substrate by using the same method as Example 13.

Next, an insulating monomolecular film of aminooctadecyl trichlorosilane was formed on the resulting substrate by using the same method as Example 9. Moreover, the resulting film was immersed for 2 hours in a solution prepared by dissolving 10 mM 1-carboxyl quarterthiophene in a non-aqueous solvent (e.g. toluene), slowly pulled up and washed with a solvent so that a conductive film containing quarterthiophene was laminated on the insulating monomolecular film containing aminooctadecane through amide bond; thus, an octadecane-quarterthiophene accumulated film serving as a functional organic thin film was obtained.

The substrate on which the octadecane-quarterthiophene accumulated film was formed, obtained through the above-mentioned processes, was measured by an infrared absorption spectrometer so that the absorption derived from amide group at wavelength of 1680 cm⁻¹ as well as at wavelength of 1520 cm⁻¹ was observed. This indicates that the amide bond is contained in the film. Moreover, the octadecane-quarter thiophene accumulated film was measured by an ultraviolet-visible absorption spectrometer so that the absorption at a wavelength of 272 nm, derived from the absorption wavelength of quarterthiophene serving as a π-electron conjugated system molecule, was detected. The octadecane-quarterthiophene accumulated film was subjected to film-thickness measurements through ellipsometry so that a measured result of a film thickness of 4.30 nm was obtained. This thickness corresponds to a film thickness formed when quarterthiophene was laminated on octadecane, and from these results, the formation of an octadecane-quarterthiophene laminated film was confirmed.

When the field-effect mobility of the resulting organic thin film transistor was evaluated by using a TOF method, a field-effect mobility of 2.0×10⁻¹ cm²/Vs was obtained. Moreover, an on/off ratio of about 6 order was obtained, thereby making it possible to provide better performances.

When a voltage is applied to each of the resulting organic thin film transistors of Examples 13 and 14 from outside, electron or hole transportation by electrons flying between adjacent molecules, so-called hopping conduction, is performed between molecules which are not bound to adjacent molecules, and it becomes possible to increase an on current. That is, when on-state, since a distance between adjacent molecules is a shorter distance by interaction between induced dipoles, the background in which hopping conduction is easily caused is obtained, and an on-current can be increased. Moreover, since there is no binding between π-electron conjugated system molecules bound to Si contained in a two-dimensional network constituted by Si and O, it is possible to decrease a leaked current at off-state. In the organic thin film transistor of the present invention, the insulating monomolecular film of the first layer, which forms a functional organic thin film corresponding to an organic semiconductor layer, has a periodic structure in a molecular level, and features that the conductive film of the second layer is formed thereon (see FIG. 6). Therefore, different from an organic thin film constituted only by π-electron conjugated system molecules, the influences from repulsion among π-electrons are made smaller so that a densely packaged structure is obtained; thus, it becomes possible to provide an organic thin film transistor having superior performances.

### COMPARATIVE EXAMPLE 2

### Formation of Octadecane-Phenyl Laminated Film and Fabrication of Organic Thin Film Transistor Using Such Laminated Film

In Comparative Example 2, first, a gate electrode, a gate insulating film, a source electrode and a drain electrode were formed on a quartz substrate by using the same method as Example 13.

Next, a monomolecular film of aminooctadecyl trichlorosilane was formed on the resulting substrate by using the same method as Example 10. Moreover, the resulting film was immersed for 2 hours in a solution prepared by dissolving 10 mM benzoic acid in a non-aqueous solvent (e.g. toluene), slowly pulled up and washed with a solvent so that a monomolecular film containing phenyl was laminated on the monomolecular film containing aminooctadecane through amide bond; thus, an octadecane-phenyl accumulated film was obtained.

The substrate on which the octadecane-phenyl accumulated film was formed, obtained through the above-mentioned processes, was measured by an infrared absorption spectrometer so that the absorption derived from amide group at wavelength of 1690 cm⁻¹ as well as at wavelength of 1540 cm⁻¹ was observed. Moreover, the octadecane-phenyl accumulated film was subjected to film-thickness measurements through ellipsometry so that a measured result of a film thickness of 3.1 nm was obtained. This thickness corresponds to a film thickness formed when benzene was laminated on octadecane, and from these results, the formation of an octadecane-phenyl accumulated film was confirmed.

However, when the field-effect mobility of the resulting organic thin film transistor was measured by using a TOF method, no mobility was observed. Consequently, it was confirmed that the octadecane-phenyl accumulated film thus formed had no semiconductor characteristics.

### EXAMPLE 15

### Formations of Organic Thin Films Using Various Insulating Molecules and π-Electron Conjugated System Molecules, and Fabrications of Organic Thin Film Transistors Using Such Thin Films

By carrying out the same processes as those of Example 9, organic thin films were formed using insulating molecules A shown in Table 1 and π-electron conjugated system molecules B indicated by the following structural formulas (*1 to 9). Additionally, Table 1 also shows the immersion time C (minutes) required upon forming an organic thin film and the infrared absorption D (cm⁻¹) of the resulting organic thin film.

Moreover, each of organic thin film transistors was fabricated by using the same method as Example 5. Here, Table 1 shows the mobility E (cm²/Vs) and ON/OFF ratio F (order) of each of the resulting organic thin film transistors.

Thus, it was confirmed that depending on combinations of the insulating molecules of Table 1 and the π-electron conjugated system molecules indicated by structural formulas (*1 to 9), organic thin film transistors having preferable performances could be obtained.

TABLE 1

| A | B (π - electron | | | | |
|---|---|---|---|---|---|
| (insulating | conjugated system | C | D | E | F |
| molecule) | molecule) | (minutes) | (cm⁻¹) | (cm²/Vs) | (order) |
| OH—(CH₂)₁₈—SiCl₃ | *1 | 70 | 1100 | 1.7 × 10⁻¹ | 5 |
| OH—(CH₂)₁₈—SiCl₃ | *2 | 90 | 1040 | 1.3 × 10⁻¹ | 5 |
| OH—(CH₂)₁₈—SiCl₃ | *3 | 15 | 1040 | 1.7 × 10⁻¹ | 5 |
| OH—(CH₂)₁₈—SiCl₃ | *4 | 120 | 1010 | 2.2 × 10⁻¹ | 6 |
| OH—(CH₂)₁₈—SiCl₃ | *5 | 30 | 1040 | 1.4 × 10⁻¹ | 5 |
| OH—(CH₂)₁₈—SiCl₃ | *6 | 10 | 1040 | 1.2 × 10⁻¹ | 5 |
| OH—(CH₂)₁₂—SiCl₃ | *7 | 120 | 1040 | 2.5 × 10⁻¹ | 5 |
| OH—(CH₂)₁₈—SiCl₃ | *8 | 40 | 1050 | 2.1 × 10⁻¹ | 6 |
| OH—(CH₂)₁₂—SiCl₃ | *9 | 55 | 1050 | 1.4 × 10⁻¹ | 5 |

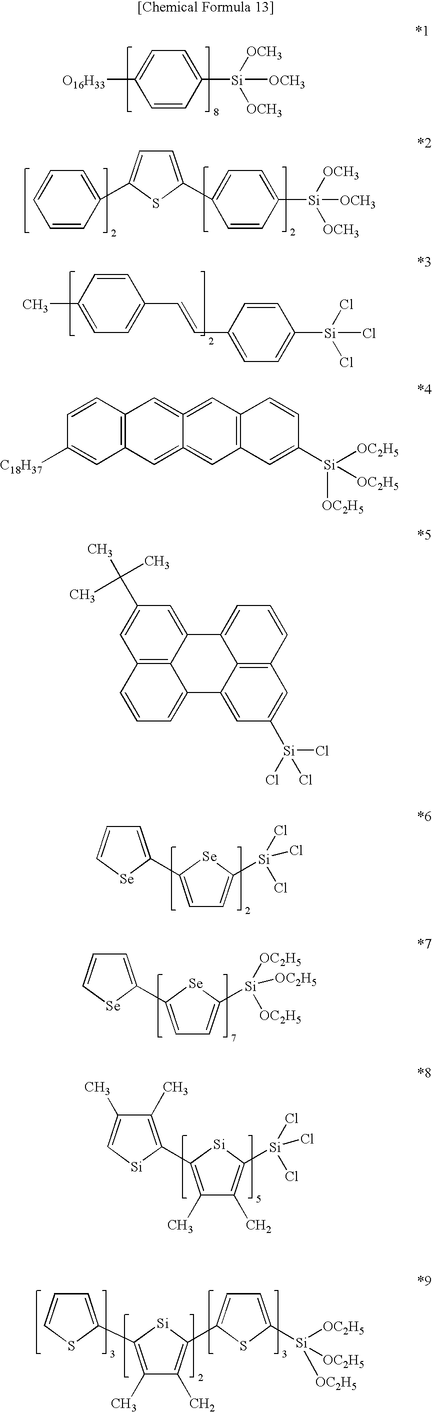

### INDUSTRIAL APPLICABILITY

The functional organic thin film of the present invention, which serves as an electric conductive material, can be widely applied not only to an organic thin film transistor material, but also to a solar cell, a fuel cell and a sensor.

The organic thin film transistor of the present invention can be applied to a variety of utilities, as semiconductor devices such as a memory, a logic element and a logic circuit, in electronic devices: e.g., data processing systems such as computer systems of personal computer, notebook, laptop, personal assistant/transmitter, minicomputer, work station, main frame, multiprocessor computer and other all types; electronic parts constituting data processing systems such as CPU, memory and data memory device; communication equipment such as telephone, PHS, modem and router; image display equipment such as display panel and projector; office work equipment such as printer, scanner and copying machine; sensor; image pickup equipment such as video camera and digital camera; leisure equipment such as gaming machine and music player; information equipment such as portable information terminal, clock and electronic dictionary; car packaging equipment such as car navigation system and car audio; AV equipment for recording and reproducing information such as animation, still picture and music; electric appliances such as washing machine, microwave oven, refrigerator, rice cooker, dish washer, vacuum cleaner and air conditioner; health managing equipment such as massager, scales and tonometer; portable-memory devices such as IC card and memory card.

### BRIEF DESCRIPTION OF THE DRAWINGS

FIGS. 1(a) to 1(c) are conceptual diagrams in molecule level, which explain film forming method (i) of a functional organic thin film of the present invention.

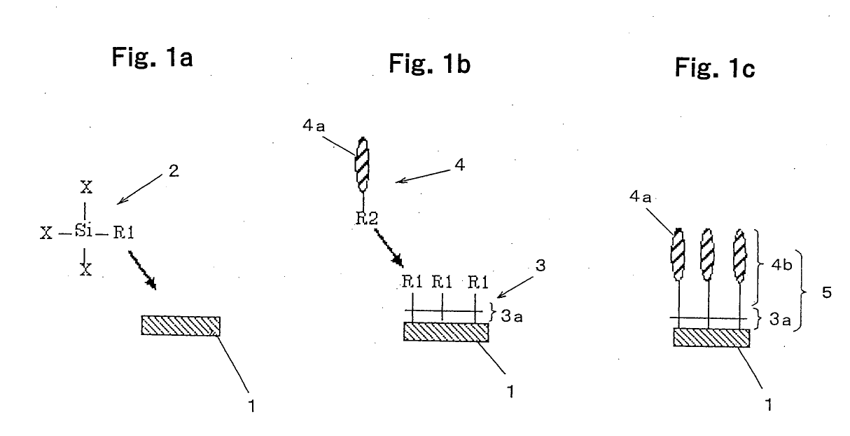

FIGS. 2(a) to 2(c) are conceptual diagrams in molecule level, which show respective processes for forming a functional organic thin film containing terthiophene of Example 1.

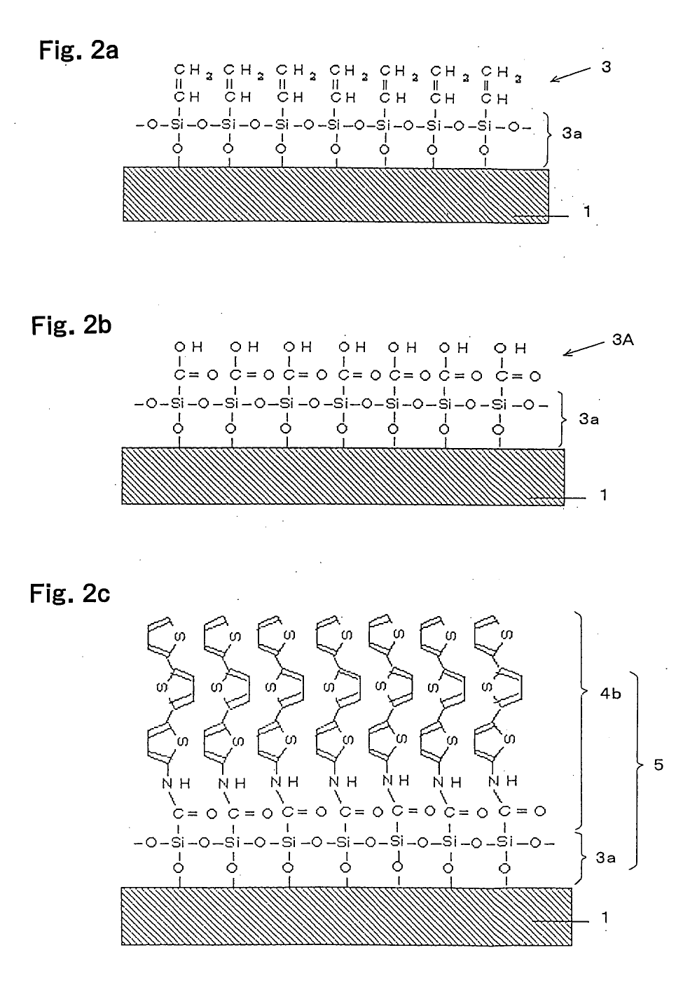

FIGS. 3(a) to 3(c) are conceptual diagrams in molecule level, which explain film forming method (ii) of a functional organic thin film of the present invention.

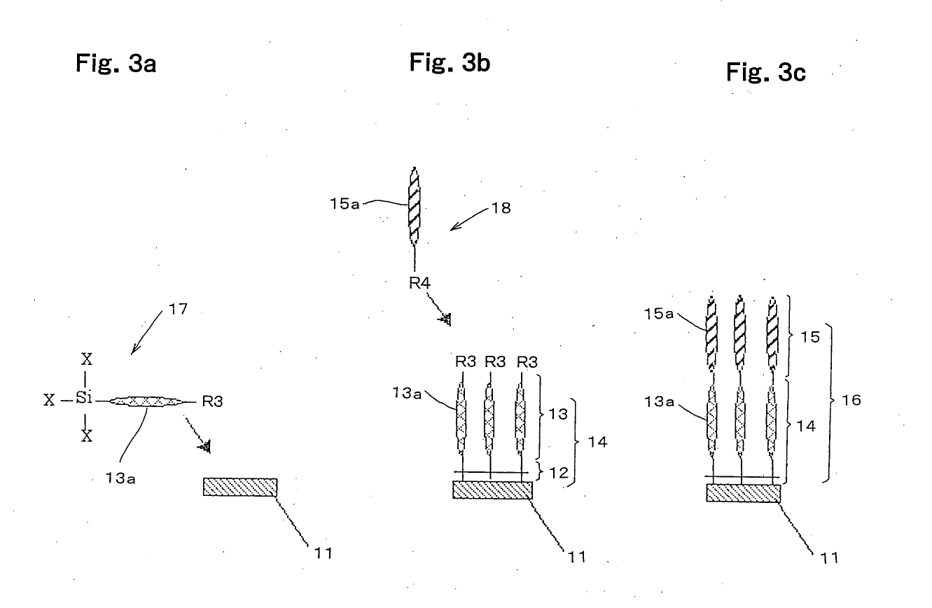

FIG. 4 is a conceptual diagram in molecule level, which shows an organic thin film transistor of the present invention.

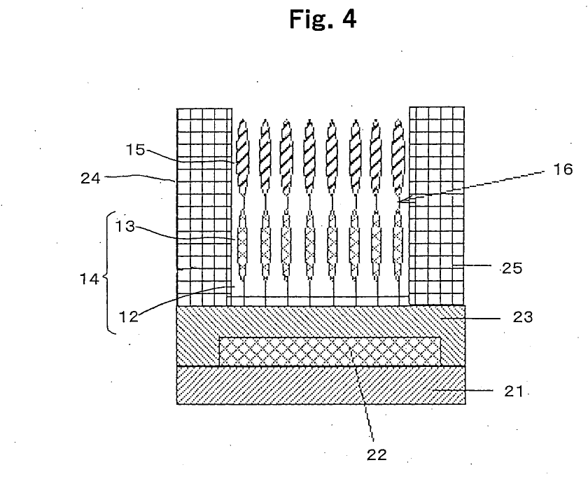

FIGS. 5(a) and 5(b) are conceptual diagrams in molecule level, which show respective processes for forming a functional organic thin film containing terthiophene in Example of the present invention.

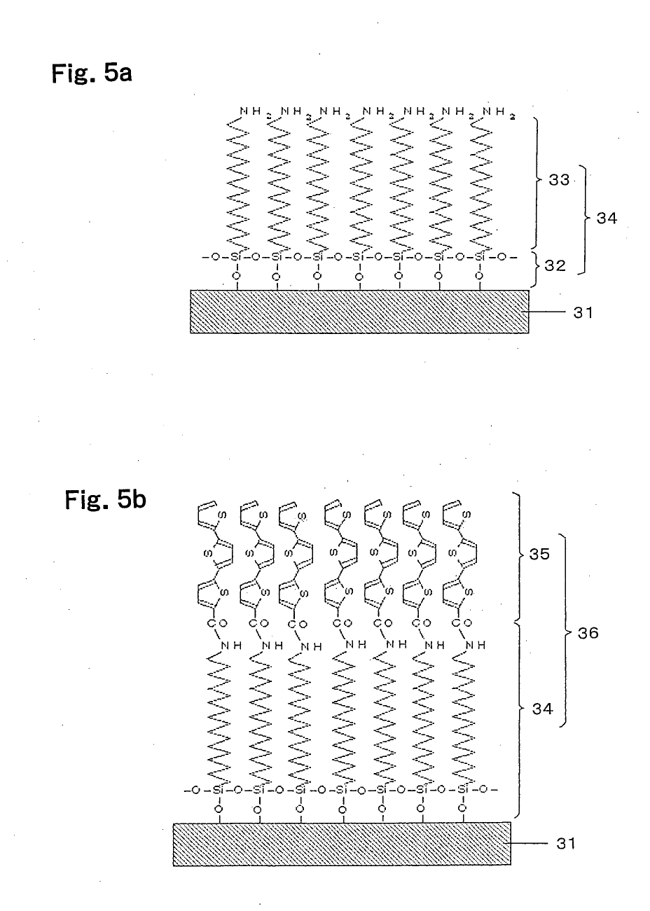

FIG. 6 is a conceptual diagram in molecule level, which shows an organic thin film transistor using an octadecane-terthiophene laminated film in Example of the present invention.

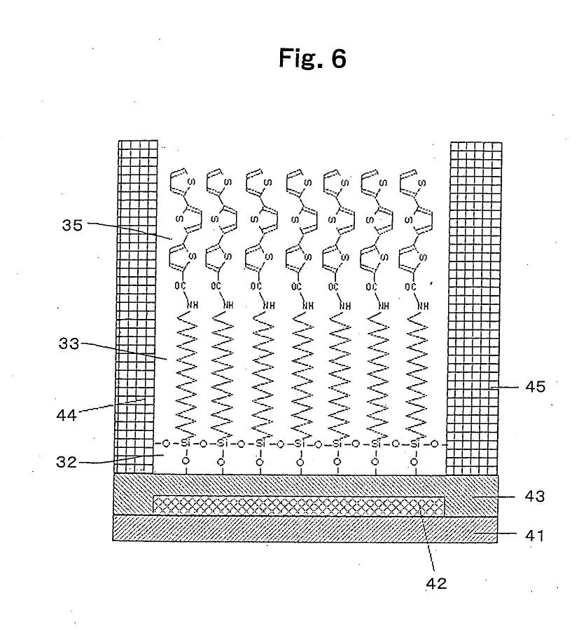

1. A functional organic thin film comprising a network structure moiety including silicon atoms and oxygen atoms and formed on a base; and a π-electron conjugated system molecule bonded to the network structure moiety via an insulating molecule.

2. The functional organic thin film as set forth in claim 1, wherein the network structure moiety has a Si—O—Si bond.

3. The functional organic thin film as set forth in claim 1, wherein the insulating molecule is a linear alkyl molecule having 12 to 30 carbon atoms.

4. The functional organic thin film as set forth in claim 1, wherein the π-electron conjugated system molecule include 2 to 30 linearly bonded units, each of the units constituting the π-electron conjugated system.

5. The functional organic thin film as set forth in claim 1, wherein each of the units constituting the π-electron conjugated system of the π-electron conjugated system molecule is one or more compounds selected from the group consisting of an aromatic hydrocarbon, a condensed polycyclic hydrocarbon, a monocyclic heterocyclic, a condensed heterocyclic, an alkene, an alkadiene and an alkatriene.

6. The functional organic thin film as set forth in claim 4, wherein each of the units constituting the π-electron conjugated system of the π-electron conjugated system molecule has an acene skeleton with 2 to 12 benzene rings.

7. The functional organic thin film as set forth in claim 4, wherein each of the units constituting the π-electron conjugated system of the π-electron conjugated system molecule is a π-electron conjugated system organic residue including at least one or more units of a monocyclic heterocyclic compound having Si, Ge, Sn, P, Se, Te, Ti or Zr as a hetero atom and one to nine units, selected from a group derived from a monocyclic aromatic hydrocarbon and a monocyclic heterocyclic compound, bonded to each other.

8. The functional organic thin film as set forth in claim 7, wherein each of the units constituting the π-electron conjugated system of the π-electron conjugated system molecule is benzene, thiophene or ethylene.

9. The functional organic thin film as set forth in claim 1, wherein the functional organic thin film is 1 to 70 nm in total film thickness.

10. The functional organic thin film as set forth in claim 1, wherein the functional organic thin film has molecular crystallinity.

11. A method for preparing a functional organic thin film, comprising:
a first step of forming a molecular thin film on a surface of a base, the molecular thin film having first functional groups periodically sticking out therefrom; and
a second step of allowing second functional groups of organic compounds to react with the first functional groups of the molecular thin film or third functional groups formed by converting the first functional groups so that an organic thin film in which the organic compounds are bonded and periodically arranged is formed on the molecular thin film.

12. The method as set forth in claim 11, wherein a forming material of the molecular thin film used in the first step is silane compounds having the first functional groups, and
in the first step, the molecular thin film is formed by bonding a network structure film moiety to the surface of the base and periodically sticking out the first functional groups from the network structure film moiety, the network structure film moiety being formed of silicon atoms and oxygen atoms as constituent atoms of the silane compounds.

13. A method for preparing a functional organic thin film, comprising:
a first step of bonding insulating molecules to a base via a network structure moiety formed of silicon atoms and oxygen atoms, the insulating molecules having first functional groups at the terminals, and
a second step of allowing second functional groups located at the terminals of π-electron conjugated system molecules to react with the first functional groups of the insulating molecules or third functional groups formed by converting the first functional groups so that the π-electron conjugated system molecules is bonded to the insulating molecules.

14. The method as set forth in claim 11, further comprising, between the first step and the second step, a middle step of converting the first functional groups of the molecular thin film to the third functional groups which can react with the second functional groups of the organic compounds.

15. The method as set forth in claim 11, wherein the organic compounds used in the second step are compounds having the second functional groups and main skeletons which are constituted of π-electron conjugated system molecules.

16. The method as set forth in claim 15, wherein each of the organic compounds has 30 or less units constituting the π-electron conjugated system contained in the π-electron conjugated system molecule, the units being linearly bonded to each other.

17. The method as set forth in claim 16, wherein each of the units constituting the π-electron conjugated system contained in the π-electron conjugated system molecule is one or more compounds selected from the group consisting of an aromatic hydrocarbon, a condensed polycyclic hydrocarbon, a monocyclic heterocyclic, a condensed heterocyclic, an alkene, an alkadiene and an alkatriene.

18. The method as set forth in claim 15, wherein each of the units constituting the π-electron conjugated system contained in the π-electron conjugated system molecule has an acene skeleton with 2 to 12 benzene rings.

19. The method as set forth in claim 15, wherein each of the units constituting the π-electron conjugated system contained in the π-electron conjugated system molecule is a π-electron conjugated system organic residue including at least one or more units of a monocyclic heterocyclic compound having Si, Ge, Sn, P, Se, Te, Ti or Zr as a hetero atom and one to nine units, selected from a group derived from a monocyclic aromatic hydrocarbon and a monocyclic heterocyclic compound, bonded to each other.

20. The method as set forth in claim 19, wherein each of the units constituting the π-electron conjugated system contained in the π-electron conjugated system molecule is benzene, thiophene or ethylene.

21. The method as set forth in claim 14,
wherein before the first step, a surface of the base is hydrophilized,
in the first step, the hydrophilized base is immersed in a solution prepared by dissolving vinyltrihalogenosilane in a non-aqueous solvent so that the molecular thin film is formed in which the network structure film moiety is bonded to the surface of the base and vinyl groups are periodically extending from a surface of the network structure film moiety,
before the second step, the resulting molecular thin film is oxidized and the vinyl groups are converted to carboxyl groups,
in a third step, the resulting base, on which the molecular thin film having the carboxyl groups is formed, is immersed in a solution prepared by dissolving aminoterthiophene in a non-aqueous solvent so that the functional organic thin film having a terthiophene monomolecular film formed on the network structure film moiety is obtained.

22. The method as set forth in claim 13,
wherein before the first step, a surface of the base is hydrophilized,
in the first step, the hydrophilized base is immersed in a solution prepared by dissolving aminooctadecyl trihalogenosilane in a non-aqueous solvent so that the network structure moiety is bonded to the surface of the base and the insulating molecules containing octadecane having an amino group at the terminal are periodically arranged on a surface of the network structure moiety,
in the second step, the base on which the insulating molecules having the amino groups are bonded thereto is immersed in a solution prepared by dissolving 1-carboxyl terthiophene in a non-aqueous solvent so that the π-electron conjugated system molecules containing terthiophene are bonded to the insulating molecules.

23. An organic thin film transistor, comprising:
a functional organic thin film formed on a surface of a substrate directly or indirectly;
a gate electrode formed on the surface of the substrate indirectly or directly;
source electrode and drain electrode formed on one surface of the functional organic thin film or on the other surface thereof; and
a gate insulating film formed between the gate electrode and the source/drain electrodes,
wherein the functional organic thin film has π-electron conjugated system molecules bonded to a network structure moiety via insulating molecules, the network structure moiety being formed of silicon atoms and oxygen atoms and formed on the base.

24. A manufacturing method of an organic thin film transistor, comprising:
a step (A) for forming a functional organic thin film on a surface of a substrate directly or indirectly;
a step (B) for forming a gate electrode on the surface of the substrate indirectly or directly;
a step (C) for forming source electrode and drain electrode on one surface of the functional organic thin film or on the other surface thereof; and
a step (D) for forming a gate insulating film between the gate electrode and the source/drain electrodes,
wherein the step (A) includes a first step of bonding insulating molecules, having first functional groups at the terminals, to the base via a network structure moiety formed of silicon atoms and oxygen atoms and a second step of reacting second functional groups located at the terminals of π-electron conjugated system molecules to the first functional groups of the insulating molecules or third functional groups formed by converting the first functional groups so that the π-electron conjugated system molecules are bonded to the insulating molecules.
